(19) United States
(12) Patent Application Publication
(10) Pub. No.: US 2013/0324040 A1
(43) Pub. Date: Dec. 5, 2013

(54) INFORMATION PROCESSING APPARATUS, WIRELESS COMMUNICATION APPARATUS, INFORMATION PROCESSING SYSTEM, AND INFORMATION PROCESSING METHOD

(71) Applicant: Sony Corporation, Tokyo (JP)

(72) Inventors: Jun Iwasaki, Tokyo (JP); Eiko Sugisaki, Kanagawa (JP)

(73) Assignee: Sony Corporation, Tokyo (JP)

(21) Appl. No.: 13/899,119

(22) Filed: May 21, 2013

(30) Foreign Application Priority Data
May 29, 2012 (JP) 2012-121482

(51) Int. Cl. H04B 5/00

(52) U.S. Cl. CPC H04B 5/00
USPC 455/41.1

(57) ABSTRACT

There is provided an information processing apparatus including a reception unit configured to receive an acquisition request for content that occurs according to near-field wireless communication to be performed by a wireless communication apparatus, and a control unit configured to control transmission of content whose use is restricted among content related to the received acquisition request and accompanying information associated with the content to the wireless communication apparatus.

### BACKGROUND

The present technology relates to an information processing apparatus, and more particularly, to an information processing apparatus, a wireless communication apparatus, an information processing system, and an information processing method that handle content.

Recently, content obtained by converting paper media publications such as magazines into electronic data can be handled by information processing apparatuses (for example, a smart phone and an electronic publication browsing apparatus). In addition, a large number of information processing apparatuses that handle the above-described content have been proposed.

For example, a communication apparatus, which exchanges content using non-contact communication, has been proposed (for example, see Japanese Unexamined Patent Application Publication No. 2012-60555).

### SUMMARY

In accordance with the above-described related art, it is possible to preferably exchange content for which the copyright is managed using non-contact communication.

Here, for example, there are a large number of bookstores that sell paper media publications, but the paper media publications can also be purchased using information processing apparatuses connected to the Internet. In addition, content obtained by converting the paper media publications into electronic data can also be purchased using the information processing apparatuses connected to the Internet.

Here, because users can actually read the publications in their hands in the bookstores, the users are assumed to easily recognize content of publications in which they are interested. In addition, most such users own wireless communication apparatuses such as smart phones.

Therefore, if publications in which the users are interested in the bookstores can be provided as content obtained by converting the publications into electronic data, this is considered to improve the ability to attract customers of the bookstores and increase sales opportunities. In addition, the users can easily obtain publications in which they are interested at a low price. In addition, if information associated with the content can also be provided to the user when the content is provided as described above, there are considered to be merits for both the user and the bookstore.

It is desirable to appropriately provide content and information associated therewith.

According to an embodiment of the present disclosure, there is provided an information processing apparatus, a method thereof and a program to cause a computer to perform the method, the information processing apparatus including a reception unit configured to receive an acquisition request for content that occurs according to near-field wireless communication to be performed by a wireless communication apparatus, and a control unit configured to control transmission of content whose use is restricted among content related to the received acquisition request and accompanying information associated with the content to the wireless communication apparatus. Thereby, content (content whose use is restricted) related to an acquisition request for content that occurs according to near-field wireless communication to be performed by the wireless communication apparatus and accompanying information associated therewith can be provided to the wireless communication apparatus.

The reception unit may be a near-field wireless communication unit that performs near-field wireless communication with the wireless communication apparatus, and the acquisition request may be received according to a timing at which the near-field wireless communication with the wireless communication apparatus began. Thereby, an acquisition request can be received according to a timing at which near-field wireless communication with the wireless communication apparatus began.

Thereby, the acquisition request can be output from one of the wireless communication apparatus and the communication apparatus according to a timing at which the near-field wireless communication between the wireless communication apparatus and the communication apparatus began.

The information processing apparatus may be connected to a communication apparatus that performs the near-field wireless communication with the wireless communication apparatus, and the acquisition request may be output from one of the wireless communication apparatus and the communication apparatus according to a timing at which the near-field wireless communication between the wireless communication apparatus and the communication apparatus began. Thereby, transmission to a wireless communication apparatus is possible by imposing a use restriction on accompanying information.

The control unit may control transmission to the wireless communication apparatus by imposing a use restriction on the accompanying information. Thereby, other content (content whose use is restricted) associated with content related to the received acquisition request can be transmitted as the accompanying information to the wireless communication apparatus.

The control unit may control transmission of key information for enabling part of the content to be available along with content related to the received acquisition request to the wireless communication apparatus. Thereby, key information for enabling part of content to be available can be transmitted to the wireless communication apparatus along with the content related to the received acquisition request.

The control unit may control transmission of service information for providing a user of the wireless communication apparatus with a predetermined service among information associated with content related to the received acquisition request as the accompanying information to the wireless communication apparatus. Thereby, information associated with content related to the received acquisition request (service information for providing a predetermined service to a user of the wireless communication apparatus) can be transmitted as accompanying information to the wireless communication apparatus.

The control unit may control a dedicated memory set in the wireless communication apparatus to store the accompanying information by transmitting the accompanying information to the wireless communication apparatus. Thereby, the accompanying information can be stored in a dedicated memory set in the wireless communication apparatus by transmitting the accompanying information to the wireless communication apparatus.

The control unit may control transmission of only the accompanying information corresponding to an allowable amount of the dedicated memory to the wireless communication apparatus. Thereby, only the accompanying information corresponding to an allowable amount of the dedicated memory can be transmitted to the wireless communication apparatus.

The control unit may determine the accompanying information based on at least one of a place in which the near-field wireless communication is performed by the wireless communication apparatus, a user of the wireless communication apparatus, a date on which the near-field wireless communication is performed, and contents of content related to the received acquisition request. Thereby, the accompanying information can be determined based on at least one of a place in which the near-field wireless communication was performed by the wireless communication apparatus, a user of the wireless communication apparatus, a date on which the near-field wireless communication was performed, and contents of content related to the received acquisition request.

According to a second embodiment of the present disclosure, there is provided a wireless communication apparatus including a control unit configured to control acquisition of content whose use is restricted among content transmitted from an information processing apparatus according to an acquisition request for content that occurs according to near-field wireless communication and accompanying information whose use is restricted among information associated with the content from the information processing apparatus and control use of the acquired content and the acquired accompanying information in a use restriction range. Thereby, content (content whose use is restricted) transmitted from the information processing apparatus according to an acquisition request for the content that occurs according to the near-field wireless communication and information (accompanying information whose use is restricted) associated therewith can be acquired from the information processing apparatus, and the acquired content and accompanying information can be used in a use restriction range.

According to a third embodiment of the present disclosure, there is provided an information processing system including a wireless communication apparatus including a control unit configured to control acquisition of content whose use is restricted among content transmitted from an information processing apparatus according to an acquisition request for content that occurs according to near-field wireless communication and accompanying information whose use is restricted among information associated with the content from the information processing apparatus and control use of the acquired content and the acquired accompanying information in a use restriction range, and the information processing apparatus including a control unit configured to control transmission of content related to the acquisition request and the accompanying information to the wireless communication apparatus. Thereby, the wireless communication apparatus can use content (content whose use is restricted) transmitted from the information processing apparatus according to an acquisition request for content that occurs according to near-field wireless communication and information (accompanying information whose use is restricted) associated therewith and use the acquired content and accompanying information in a use restriction range, and the information processing apparatus can transmit content (content whose use is restricted) and accompanying information (accompanying information whose use is restricted) to the wireless communication apparatus.

According to the embodiments of the present technology described above, an excellent effect of appropriately providing content and information associated therewith can be obtained.

### BRIEF DESCRIPTION OF THE DRAWINGS

FIG. 1 is a block diagram illustrating a system configuration example of an information processing system in a first embodiment of the present technology;

FIG. 2 is a block diagram illustrating a functional configuration example of a content server in the first embodiment of the present technology;

FIG. 3 is a diagram schematically illustrating a content management DB in the first embodiment of the present technology;

FIG. 4 is a block diagram illustrating a functional configuration example of a license server in the first embodiment of the present technology;

FIG. 5 is a diagram schematically illustrating a license key management DB in the first embodiment of the present technology;

FIG. 6 is a diagram schematically illustrating a domain management DB in the first embodiment of the present technology;

FIG. 7 is a block diagram illustrating a functional configuration example of a wireless communication apparatus in the first embodiment of the present technology;

FIG. 8 is a simplified diagram illustrating an example of transition of acquisition when content (content whose use is restricted) is acquired using the wireless communication apparatus in the first embodiment of the present technology;

FIG. 9 is a simplified diagram illustrating a data flow upon acquisition when content (content whose use is restricted) is acquired using the wireless communication apparatus in the first embodiment of the present technology;

FIG. 10 is a diagram illustrating an example (a display screen) of a display screen displayed on a display unit in the first embodiment of the present technology;

FIG. 11 is a diagram illustrating an example (a display screen) of a display screen displayed on the display unit in the first embodiment of the present technology;

FIG. 12 is a simplified example illustrating a flow of data upon acquisition when a license key is acquired using the wireless communication apparatus in the first embodiment of the present technology;

FIG. 13 is a diagram illustrating an example (a display screen) of a display screen displayed on the display unit in the first embodiment of the present technology;

FIG. 14 is a sequence chart illustrating an example of a communication process between devices constituting an information processing system in the first embodiment of the present technology;

FIG. 15 is a flowchart illustrating an example of a processing procedure of a content transmission process by a content server in the first embodiment of the present technology;

FIG. 16 is a flowchart illustrating an example of a processing procedure of a content acquisition process by the wireless communication apparatus in the first embodiment of the present technology;

FIG. 17 is a simplified diagram illustrating a flow of data upon acquisition when content (content whose use is restricted) is acquired using the wireless communication apparatus in the first embodiment of the present technology;

FIG. 18 is a diagram illustrating an example (a display screen) of a display screen displayed on the display unit in the first embodiment of the present technology;

FIG. 19 is a diagram illustrating an example (a display screen) of a display screen displayed on the display unit in the first embodiment of the present technology;

FIG. 20 is a diagram illustrating an example (a display screen) of a display screen displayed on the display unit in the first embodiment of the present technology;

FIG. 21 is a sequence chart illustrating an example of a communication process between devices constituting the information processing system in the first embodiment of the present technology;

FIG. 22 is a sequence chart illustrating an example of a communication process between devices constituting the information processing system in the first embodiment of the present technology;

FIG. 23 is a diagram schematically illustrating an example of a memory capacity of a storage unit in a second embodiment of the present technology;

FIG. 24 is a flowchart illustrating an example of a processing procedure of a content transmission process by a content server in the second embodiment of the present technology;

FIG. 25 is a simplified diagram when content and its license key are copied between a wireless communication apparatus and a wireless communication apparatus in a third embodiment of the present technology;

FIG. 26 is a simplified diagram illustrating a flow of data upon acquisition when a domain key is acquired using the wireless communication apparatus in the third embodiment of the present technology;

FIG. 27 is a sequence chart illustrating an example of a communication process between devices constituting an information processing system in the third embodiment of the present technology;

FIG. 28 is a sequence chart illustrating an example of a communication process between devices constituting the information processing system in the third embodiment of the present technology;

FIG. 29 is a flowchart illustrating an example of a processing procedure of a domain registration process by the wireless communication apparatus in the third embodiment of the present technology; and

FIG. 30 is a flowchart illustrating an example of a processing procedure of a content copy process by the wireless communication apparatus in the third embodiment of the present technology.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, modes (hereinafter referred to as the embodiments) for carrying out the present technology will be described. The description will be given in the following order.

1. First Embodiment (Communication Control: Example in Which Accompanying Information Is Transmitted Along with Content Related to Trial Reading Request)

2. Second Embodiment (Communication Control: Example in Which Accompanying Information Is Changed According to Capacity of Dedicated Area for Accompanying Information of Storage Unit of Wireless Communication Apparatus)

3. Third Embodiment (Communication Control: Example in Which Downloaded Content Is Copied to Other Wireless Communication Apparatus and Used)

### 1. First Embodiment

[Configuration Example of Information Processing System]

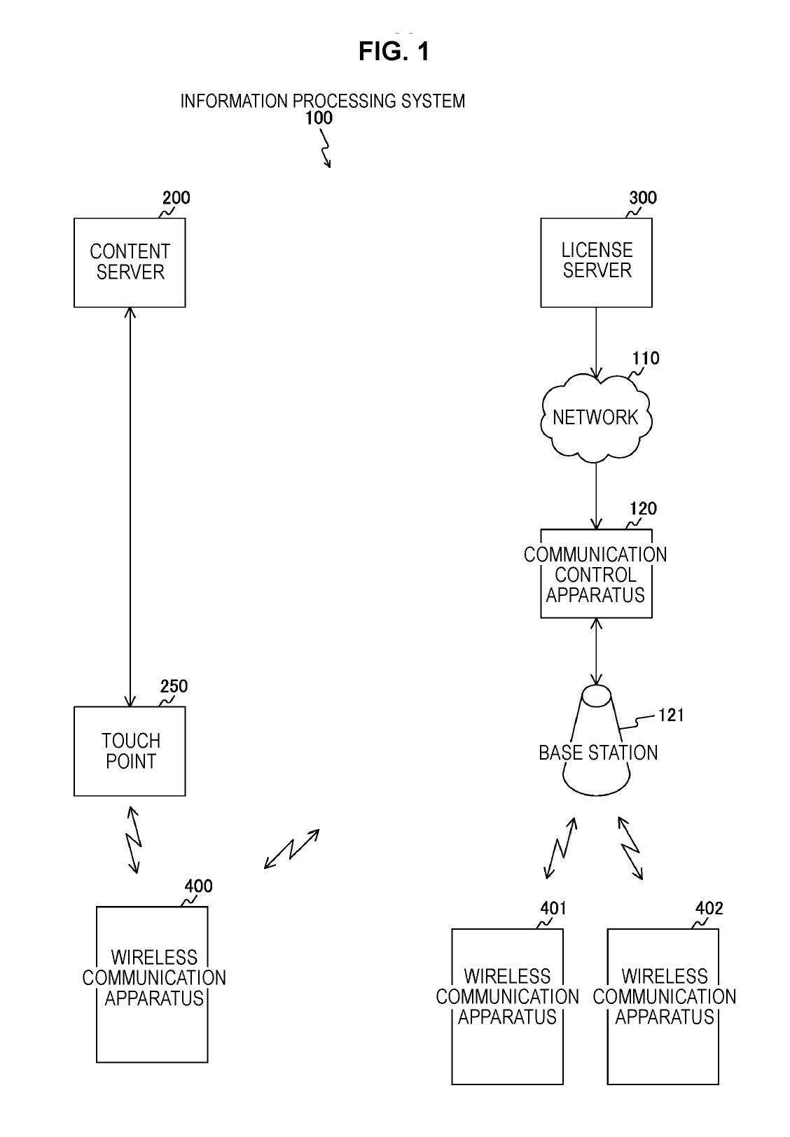

FIG. 1 is a block diagram illustrating a system configuration example of an information processing system 100 in the first embodiment of the present technology.

The information processing system 100 includes a network 110, a communication control apparatus 120, a base station 121, a content server 200, a touch point 250, a license server 300, and wireless communication apparatuses 400 to 402.

The network 110 is a network (for example, a public network) such as a telephone network or the Internet. In addition, the network 110 and the communication control apparatus 120 are connected via a gateway (not illustrated).

The communication control apparatus 120 is a communication control apparatus managed by a communication provider, which provides a wireless connection service. For example, the communication control apparatus 120 is installed by the communication provider (for example, a portable telephone provider) that provides a wireless connection service (for example, a wireless connection service using a third generation (3G) network).

For example, the communication control apparatus 120 controls authentication of the wireless communication apparatus connected via the base station 121. For example, the communication control apparatus 120 authenticates the wireless communication apparatus that holds authentication information (for example, a universal subscriber identity module (USIM)) of the communication control apparatus 120 among wireless communication apparatuses connected via the base station 121. Therefore, the communication control apparatus 120 connects the authenticated wireless communication apparatus to the network 110 via the gateway (not illustrated).

The base station 121 is a mobile communication base station (Node B), which connects the authenticated wireless communication apparatus and the communication control apparatus 120 via a wireless link.

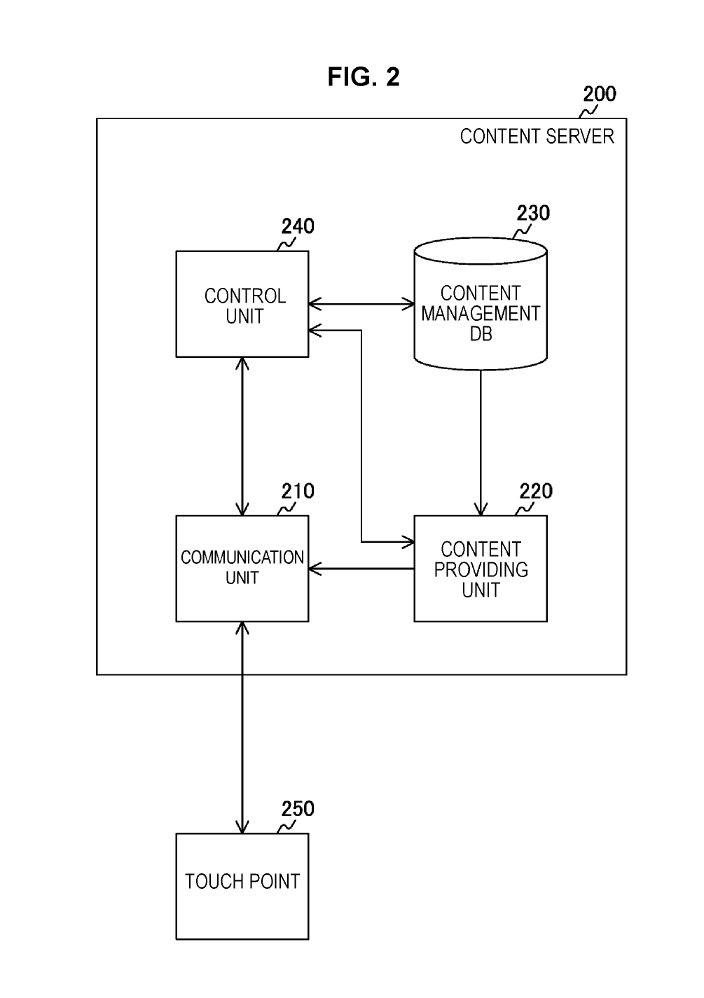

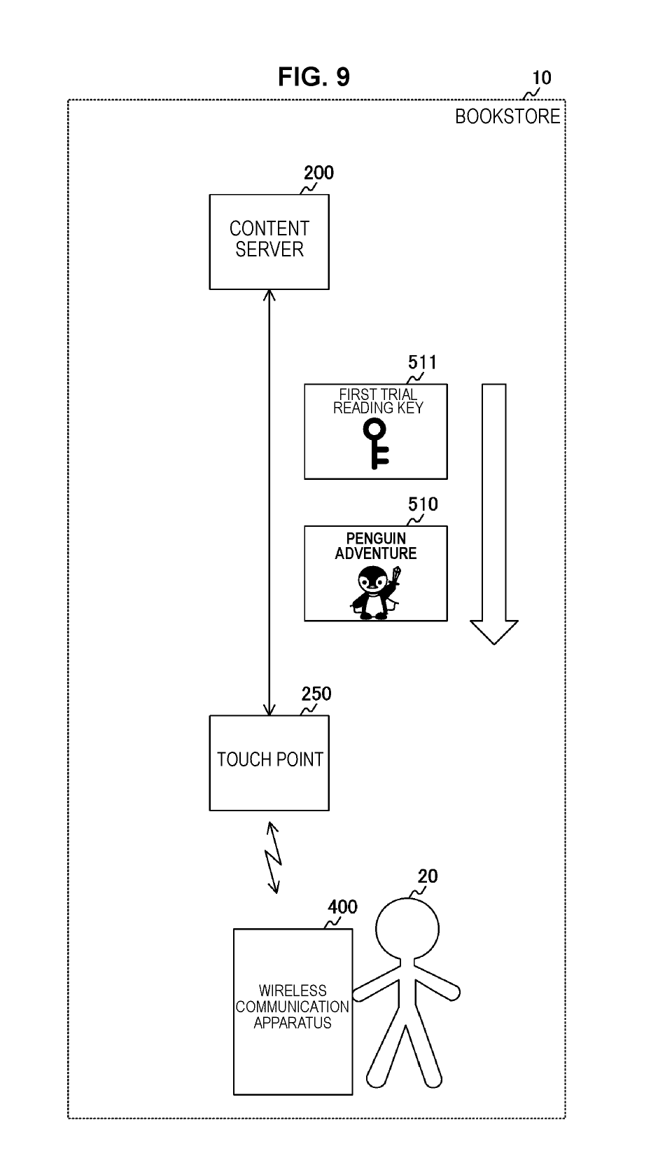

The content server 200 is an information processing apparatus, which provides various content via the touch point 250, and provides various content to the wireless communication apparatus 400 using near-field wireless communication. For example, as illustrated in FIG. 9, the content server 200 is installed within a bookstore 10. Also, the content server 200 will be described in detail with reference to FIG. 2. Also, the content server 200 is an example of an information processing apparatus disclosed in the claims.

The touch point 250 is a communication apparatus for performing near-field wireless communication with the wireless communication apparatus 400. For example, as illustrated in FIG. 9, the touch point 250 is installed for one or more publications within the bookstore 10. Also, the touch point 250 is an example of a communication apparatus and an information processing apparatus disclosed in the claims.

Here, in the first embodiment of the present technology, an example in which non-contact communication is used as the near-field wireless communication is shown. The non-contact communication is wireless communication in which data is transmitted at a transmission distance of 0 to about several tens of centimeters (cm), an effect of interference is small because reflected waves from a reflecting object in the vicinity are small, hacking on a transmission path can be prevented, and secrecy can be secured. In addition, the communication distance in the non-contact communication is limited to several centimeters (cm), so that it is possible to speed up a communication process, reduce a size of a wireless communication apparatus (electronic device), and accomplish power saving. In addition, the non-contact communication, for example, is implemented by a non-contact communication scheme such as an electrostatic coupling scheme, an electromagnetic induction scheme, or a radio wave communication scheme.

An example in which proximity wireless transfer technology (TransferJet (registered trademark)) using a weak ultra wide band (UWB) signal is used in the first embodiment of the present technology as non-contact communication technology applicable to high-speed communication is shown. TransferJet is a scheme of transmitting a signal basically using the coupling action of an induced electric field. In addition, the wireless communication apparatus of TransferJet includes a communication circuit unit, which processes a radio frequency signal, a coupling electrode arranged separated by a certain level with respect to the ground, and a resonance unit, which efficiently supplies a radio frequency signal to a coupling electrode. That is, the touch point 250 and the wireless communication apparatus 400 include the above-described parts.

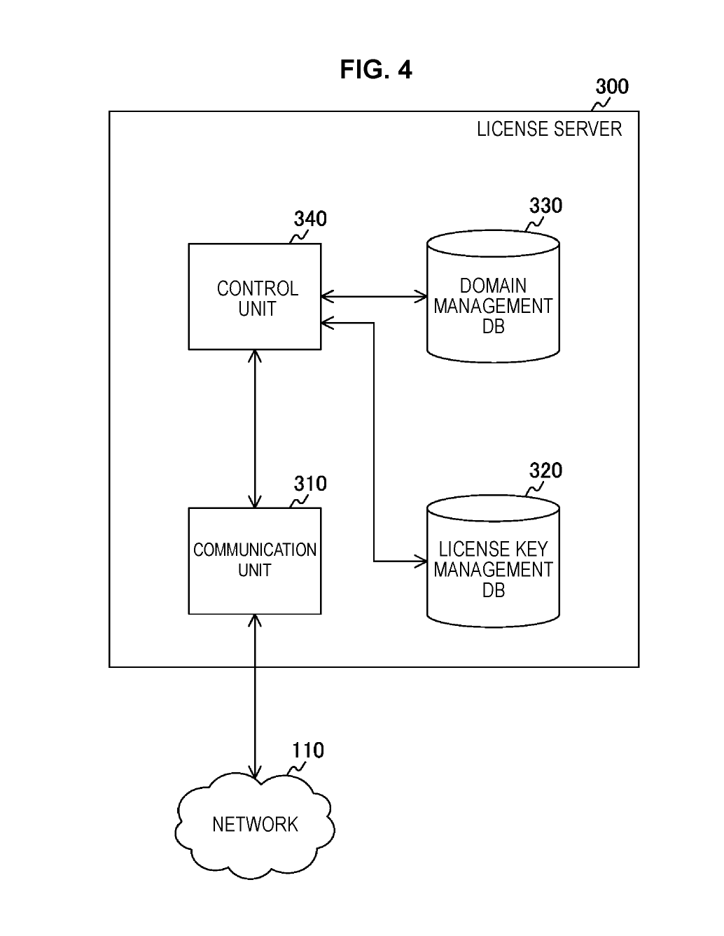

The license server 300 is an information processing apparatus that controls various licenses for wireless communication apparatuses 400 to 402 connected via the base station 121. For example, the license server 300 transmits a license key used to use all content provided from the content server 200 according to a request from the wireless communication apparatus. Also, the license server 300 will be described in detail with reference to FIG. 4.

The wireless communication apparatuses 400 to 402 are wireless communication apparatuses (electronic devices) communicable with the license server 300 via the communication control apparatus 120 using wireless communication. The wireless communication apparatus 400, for example, is a smart phone (for example, an information processing apparatus including a telephone function and a data communication function), and the wireless communication apparatus 401, for example, is a tablet personal computer (PC). In addition, the wireless communication apparatus 402, for example, is an electronic publication display apparatus including a wireless communication function. Also, for example, an imaging apparatus (for example, a digital still camera or a digital video camera (for example, a camera-integrated recorder)) including the wireless communication function, and a sound output apparatus (for example, a portable music player) including the wireless communication function may be used. In addition, for example, an information processing apparatus (for example, a PC without the wireless communication function) capable of performing wireless communication may be used by mounting a wireless communication device including the wireless communication function.

For example, the wireless communication apparatuses 400 to 402 can be connected to the communication control apparatus 120 via the base station 121 based on authentication information and connected to the network 110. In addition, for example, the wireless communication apparatuses 400 to 402 can be connected to the content server 200 via the touch point 250 using the near-field wireless communication. In addition, the wireless communication apparatuses 400 to 402 can be mutually connected using the near-field wireless communication, thereby transmitting/receiving data. Also, an example of communication between two wireless communication apparatuses is shown in the third embodiment of the present technology.

[Configuration Example of Content Server]

FIG. 2 is a block diagram illustrating a functional configuration example of the content server 200 in the first embodiment of the present technology.

The content server 200 includes a communication unit 210, a content providing unit 220, a content management database (DB) 230, and a control unit 240.

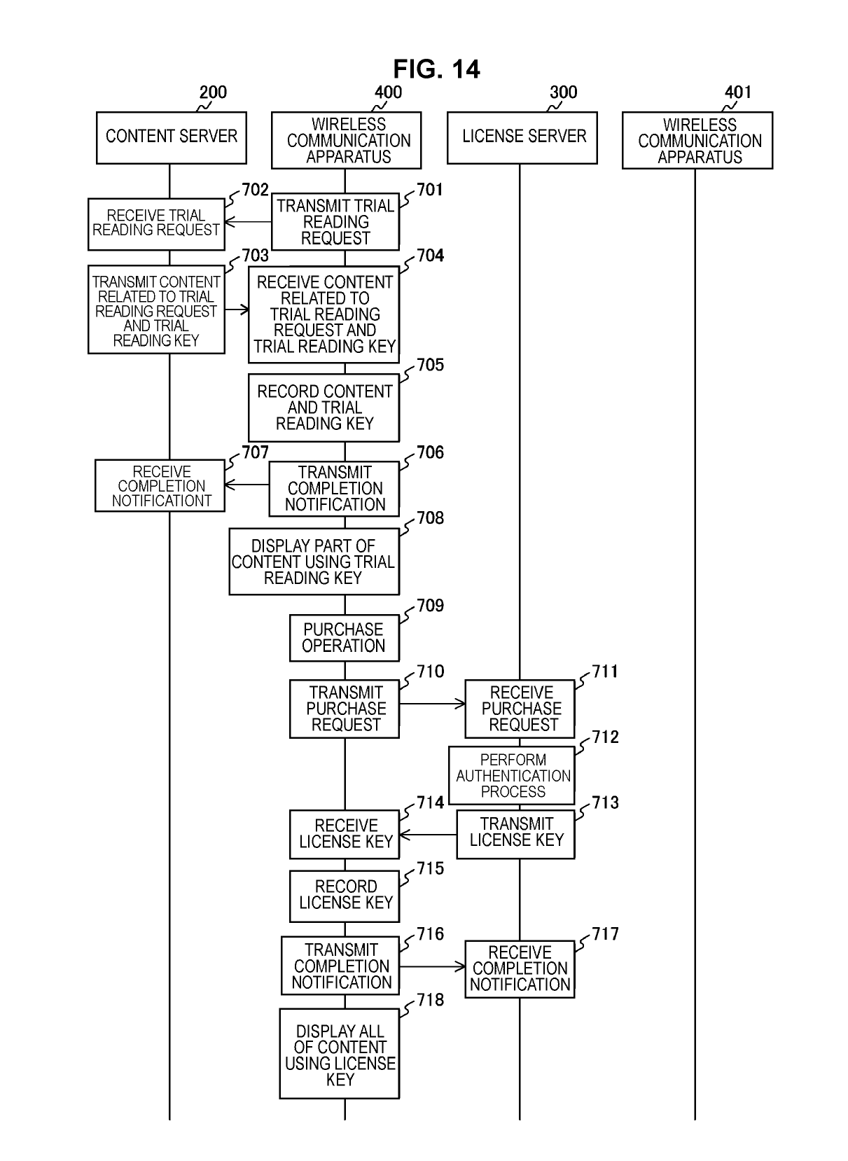

The communication unit 210 is connected to the touch point 250 and communicates with the wireless communication apparatus 400 connected via the touch point 250 based on control of the control unit 240. For example, the communication unit 210 receives information (for example, a trial reading request illustrated in FIG. 14) transmitted from the wireless communication apparatus 400 via the touch point 250, and outputs the received information to the control unit 240. In addition, the communication unit 210 transmits various content output from the content providing unit 220 to the wireless communication apparatus 400 via the touch point 250. Also, the communication unit 210 is an example of a reception unit disclosed in the claims.

Based on the control of the control unit 240, the content providing unit 220 provides the wireless communication apparatus 400 with various content corresponding to a request from the wireless communication apparatus 400 connected via the touch point 250. In addition, the content providing unit 220 uses various data stored in the content management DB 230 when providing various content. For example, when the trial reading request has been received from the wireless communication apparatus 400, the content providing unit 220 acquires content (for example, electronic publication content and a trial reading key) related to the request from the content management DB 230. Therefore, the content providing unit 220 transmits the acquired content to the wireless communication apparatus 400 via the communication unit 210.

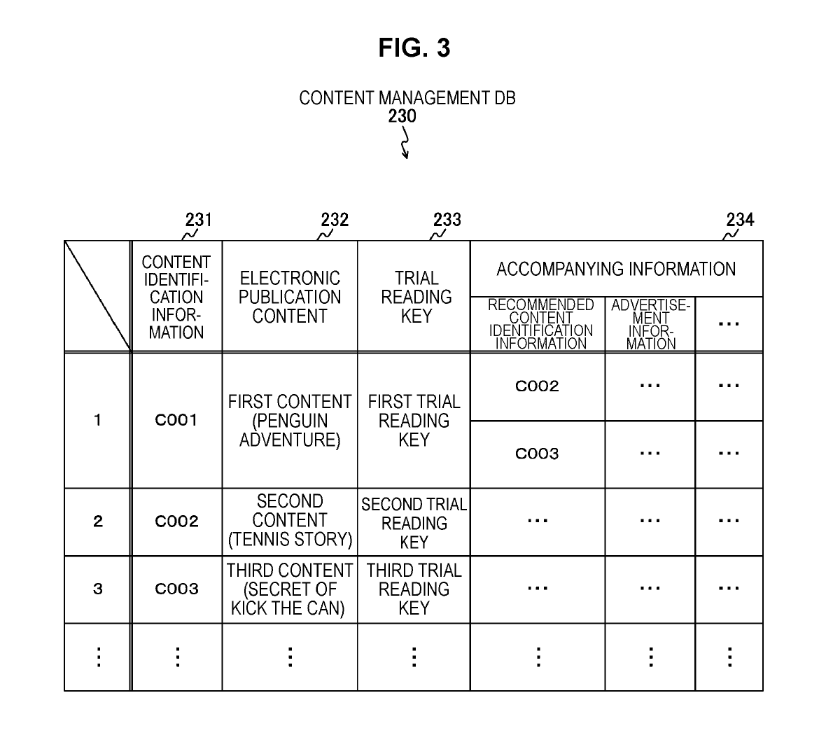

The content management DB 230 is a DB that stores various content to be provided to each wireless communication apparatus. Also, the content management DB 230 will be described in detail with reference to FIG. 3.

The control unit 240 performs control related to communication with the wireless communication apparatus 400 connected via the touch point 250. For example, the control unit 240 performs control for performing a content providing process (communication process). Also, the content providing process is a communication process for providing content from the content server 200 to the wireless communication apparatus 400 (a communication process for downloading content from the content server 200 to the wireless communication apparatus 400).

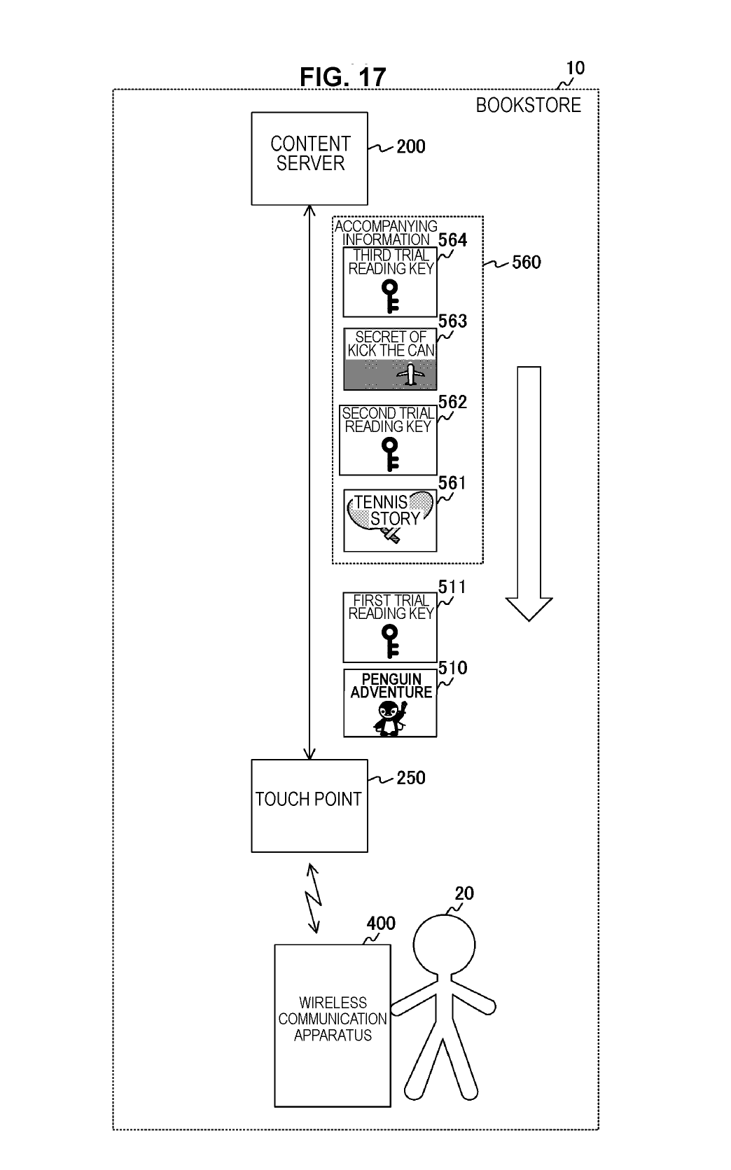

In addition, for example, when an acquisition request (for example, the trial reading request illustrated in FIG. 14) has been received, the control unit 240 controls transmission of content (content whose use is restricted) related to the acquisition request and accompanying information associated therewith to the wireless communication apparatus. In this case, the control unit 240, for example, controls transmission of key information (for example, a first trial reading key 511 illustrated in FIGS. 9 and 17) for enabling part of the content to be used to the wireless communication apparatus along with the content related to the received acquisition request.

Here, the accompanying information, for example, is other content (content whose use is restricted) associated with the content related to its acquisition request, and, for example, is accompanying information 560 illustrated in FIG. 17. In this case, the control unit 240, for example, controls transmission of the accompanying information to the wireless communication apparatus whose use is restricted. For example, key information (for example, a second trial reading key 562 and a third trial reading key 564 illustrated in FIG. 17) for enabling part of the other content to be used is transmitted together to the wireless communication apparatus.

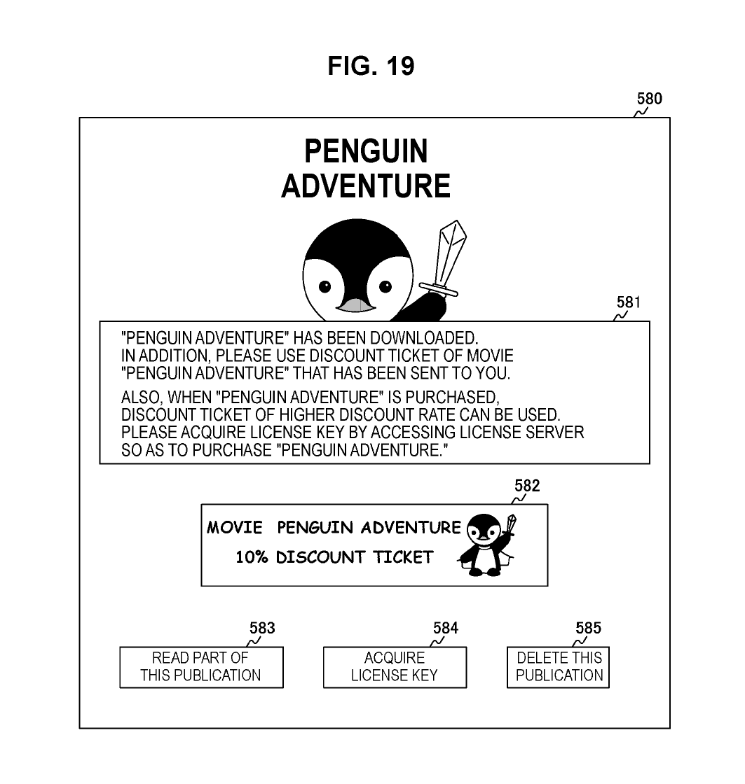

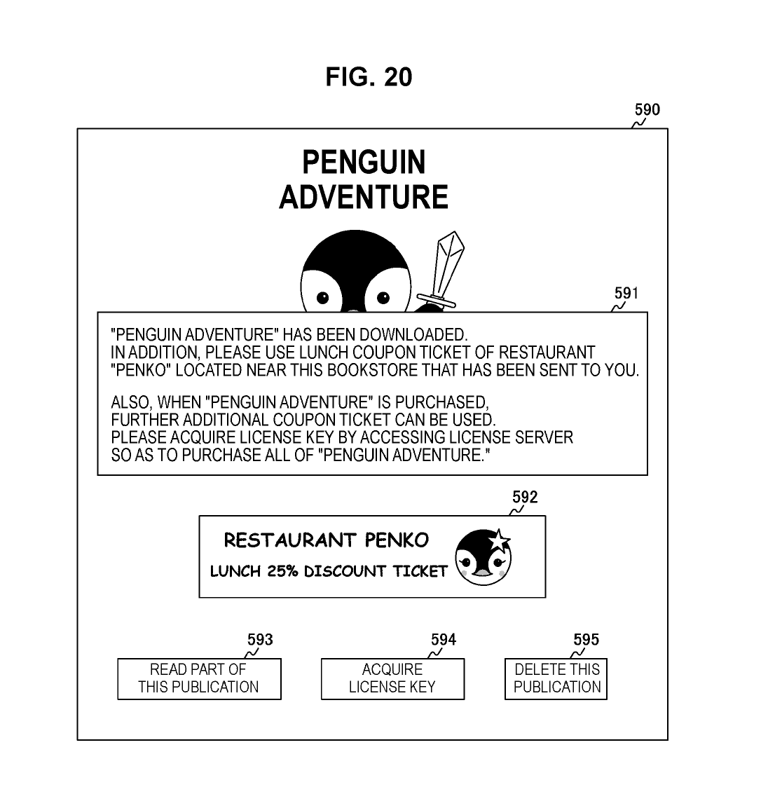

In addition, the accompanying information, for example, is service information associated with the content related to its acquisition request (service information for providing a predetermined service to a user of the wireless communication apparatus transmitting the acquisition request), and, for example, is a coupon or a discount ticket. A display example of the service information is illustrated in FIGS. 19 and 20.

[Configuration Example of Content Management DB]

FIG. 3 is a diagram schematically illustrating the content management DB 230 in the first embodiment of the present technology.

In the content management DB 230, content identification information 231, electronic publication content 232, a trial reading key 233, and accompanying information 234 are associated and stored. The above-described information, for example, is sequentially updated by the control unit 240 based on a registration correction request from a representative of a bookstore in which the content server 200 is installed.

In the content identification information 231, identification information for identifying content is stored.

In the electronic publication content 232, electronic publication content to be provided to the wireless communication apparatus is stored.

In the trial reading key 233, key information for trial reading of part of electronic publication content to be provided to the wireless communication apparatus is stored.

Here, in general, paid content is subjected to digital right management (DRM) so as to prevent unlimited use by unauthorized copying. Thus, in order to display content subjected to the DRM, a license key is necessary in addition to data of a content body.

In addition, the trial reading key is a key (for example, a key for releasing part of the use restriction) for enabling only part of the content subjected to the DRM (a preset part (for example, a table of contents or several major pages)) to be freely displayed.

In the accompanying information 234, various information to be transmitted along with electronic publication content related to a trial reading request from the wireless communication apparatus is stored. For example, identification information of content to be recommended to a user of the wireless communication apparatus transmitting the trial reading request is stored. In addition, advertisement information to be provided to the user of the wireless communication apparatus transmitting the trial reading request is stored. As described above, in the accompanying information 234, various information (for example, recommendation information and an advertisement) associated with content related to a trial reading request from the wireless communication apparatus is stored.

[Configuration Example of License Server]

FIG. 4 is a block diagram illustrating a functional configuration example of the license server 300 in the first embodiment of the present technology.

The license server 300 includes a communication unit 310, a license key management DB 320, a domain management DB 330, and a control unit 340.

The communication unit 310 is connected to the network 110, and performs communication between the wireless communication apparatuses 400 to 402 connected via the network 110 based on control of the control unit 340. For example, the communication unit 310 receives information (for example, a purchase request illustrated in FIG. 14) transmitted from the wireless communication apparatus 400 via the network 110, and outputs the received information to the control unit 340. In addition, the communication unit 310 transmits information stored in the license key management DB 320 and the domain management DB 330 to the wireless communication apparatuses 400 to 402.

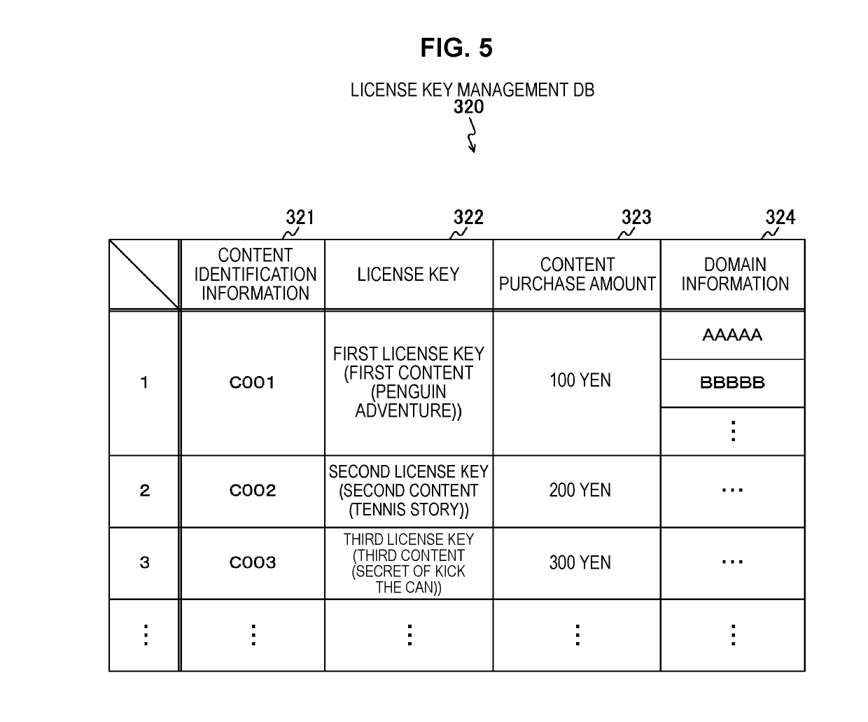

The license key management DB 320 is a DB that stores a license key to be provided to each wireless communication apparatus. Also, the license key management DB 320 will be described in detail with reference to FIG. 5.

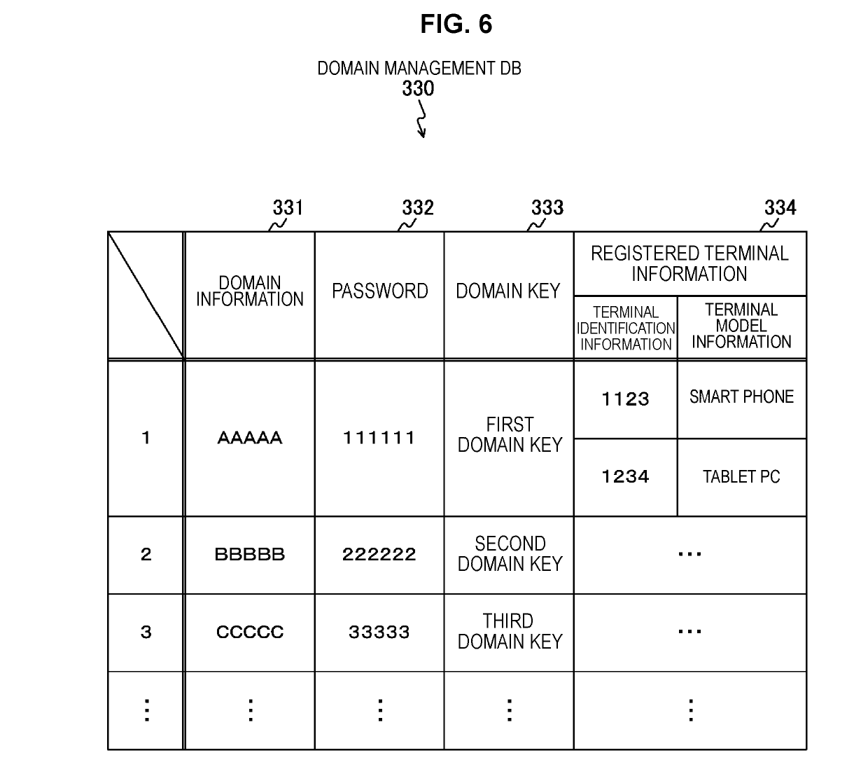

The domain management DB 330 is a DB that stores a domain key to be provided to each wireless communication apparatus. Here, the domain key is the same key as assigned to an electronic device sharing content. Also, the domain management DB 330 will be described in detail with reference to FIG. 6.

The control unit 340 performs control related to communication to be performed between the wireless communication apparatuses 400 to 402 connected via the network 110. For example, the control unit 340 performs control for providing the license key or the domain key.

[Configuration Example of License Key Management DB]

FIG. 5 is a diagram schematically illustrating the license key management DB 320 in the first embodiment of the present technology.

In the license key management DB 320, content identification information 321, a license key 322, a content purchase amount 323, and domain information 324 are associated and stored. The above-described information, for example, is sequentially updated by the control unit 340 based on a registration correction request from a content sales representative.

In the content identification information 321, identification information for identifying content is stored. Also, the content identification information 321 corresponds to the content identification information 231 illustrated in FIG. 3.

In the license key 322, a license key for displaying electronic publication content to be provided to the wireless communication apparatus is stored.

In the content purchase amount 323, information related to an amount of purchase money for purchasing content is stored. For example, a process of transmitting the license key is performed on condition of payment of an amount of purchase money stored in the content purchase amount 323.

In the domain information 324, domain information (domain information 331 illustrated in FIG. 6) managed by the domain management DB 330 is stored. For example, domain information of a user purchasing a license key is stored in association with content identification information related to the license key. Thereby, it is possible to specify the user purchasing the license key.

[Configuration Example of Domain Management DB]

FIG. 6 is a diagram schematically illustrating the domain management DB 330 in the first embodiment of the present technology.

In the domain management DB 330, the domain information 331, a password 332, a domain key 333, and registered terminal information 334 are associated and stored. The above-described information, for example, is sequentially updated by the control unit 340 based on a request from the wireless communication apparatus that performs each procedure related to domain registration.

The domain information 331 is domain information assigned to each user (wireless communication apparatus) performing domain registration. For example, the domain information can be shared by one or more wireless communication apparatuses.

The password 332 is a password to be used when a domain key is acquired by performing the domain registration.

In the domain key 333, a domain key necessary when content downloaded from the content server 200 is copied to and displayed on another wireless communication apparatus is stored.

In the registered terminal information 334, terminal identification information (for example, an ID unique to a device) and terminal model information for identifying the wireless communication apparatus subjected to the domain registration is stored.

For example, the terminal identification information of the wireless communication apparatus 400 is assumed to be “1123” and the terminal identification information of the wireless communication apparatus 401 is assumed to be “1234.”

Also, a domain registration example and an example in which the content downloaded from the content server 200 is copied to another wireless communication apparatus will be described in the third embodiment of the present technology.

[Configuration Example of Wireless Communication Apparatus]

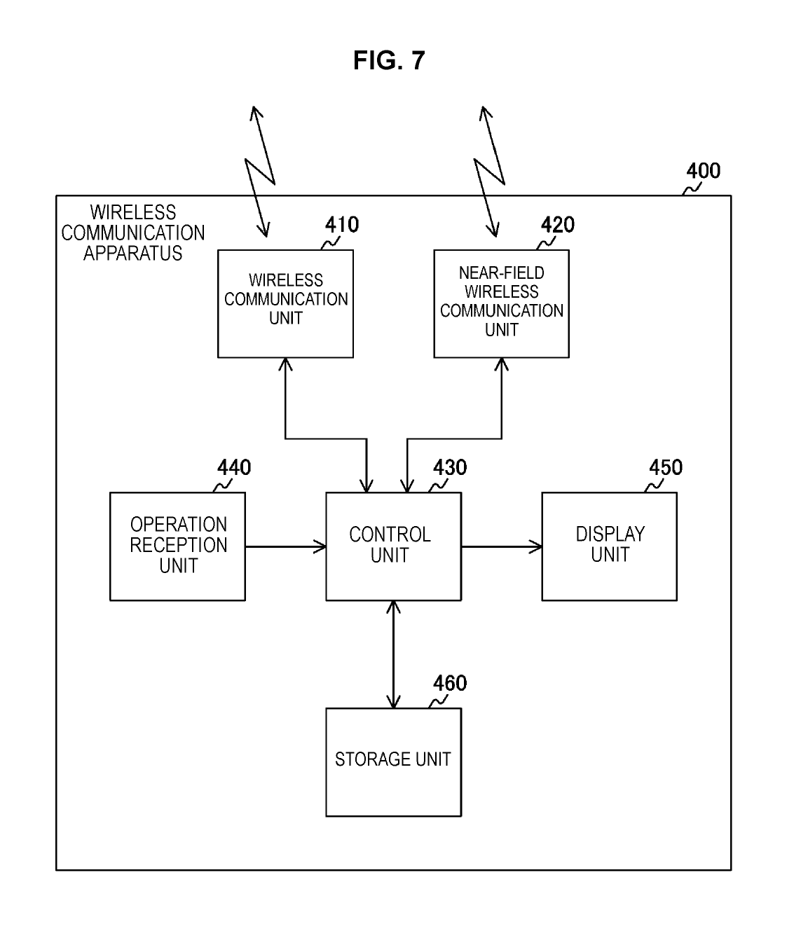

FIG. 7 is a block diagram illustrating a functional configuration example of the wireless communication apparatus 400 in the first embodiment of the present technology. Also, because functional configurations of the wireless communication apparatuses 401 and 402 are substantially the same as that of the wireless communication apparatus 400, description thereof is omitted here.

The wireless communication apparatus 400 includes a wireless communication unit 410, a near-field wireless communication unit 420, a control unit 430, an operation reception unit 440, a display unit 450, and a storage unit 460. Also, the illustration and description of a microphone and a speaker are omitted.

The wireless communication unit 410 performs wireless communication corresponding to a predetermined communication scheme based on control of the control unit 430. For example, the wireless communication unit 410 performs wireless communication using a 3G network.

The near-field wireless communication unit 420 performs wireless communication corresponding to a near-field wireless communication scheme with the touch point 250 based on control of the control unit 430. Here, an example in which TransferJet is used as the near-field wireless communication scheme in the first embodiment of the present technology as described above is shown.

The control unit 430 performs various control operations based on a control program stored in a memory (not illustrated). The control unit 430, for example, includes a microprocessor. For example, the control unit 430 is connected to the wireless communication unit 410, and transmits/receives various data to/from the communication control apparatus 120 connected via the base station 121. In addition, for example, the control unit 430 is connected to the near-field wireless communication unit 420, and transmits/receives various data to/from the content server 200 connected via the touch point 250.

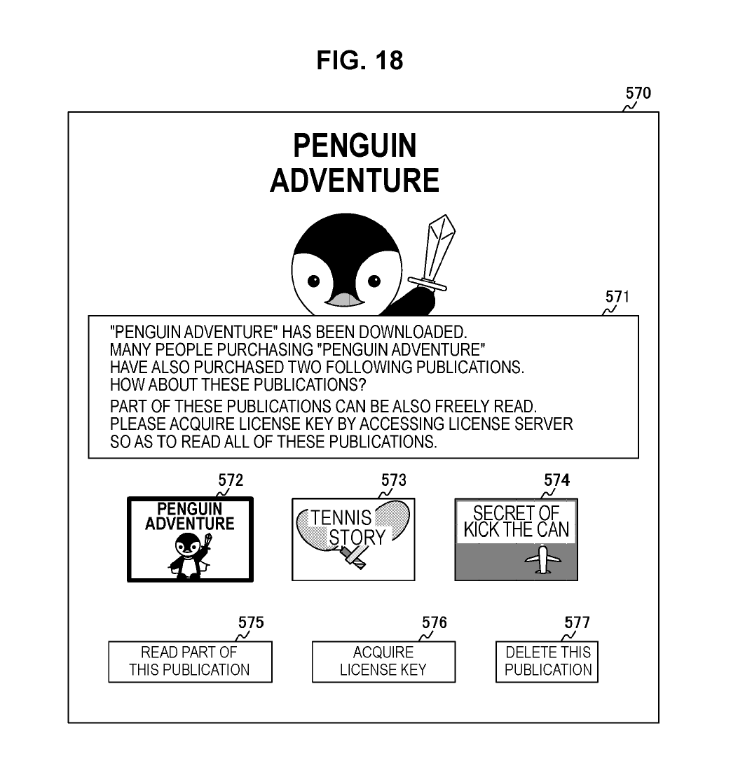

In addition, for example, the control unit 430 controls transmission of a trial reading request for content to the content server 200. In this case, the control unit 430 controls acquisition of content (content whose use is restricted) related to the trial reading request and accompanying information (accompanying information whose use is restricted) associated therewith from the content server 200. Therefore, the control unit 430 controls the use of the acquired content and the acquired accompanying information in a use restriction range. For example, as illustrated in FIGS. 18 to 20, information is displayed in the use restriction range.

The operation reception unit 440 is an operation reception unit that receives an operation input operated by the user, and outputs a signal corresponding to the received operation input to the control unit 430. The operation reception unit 440, for example, includes various keys such as numeric keys and alphabetic keys.

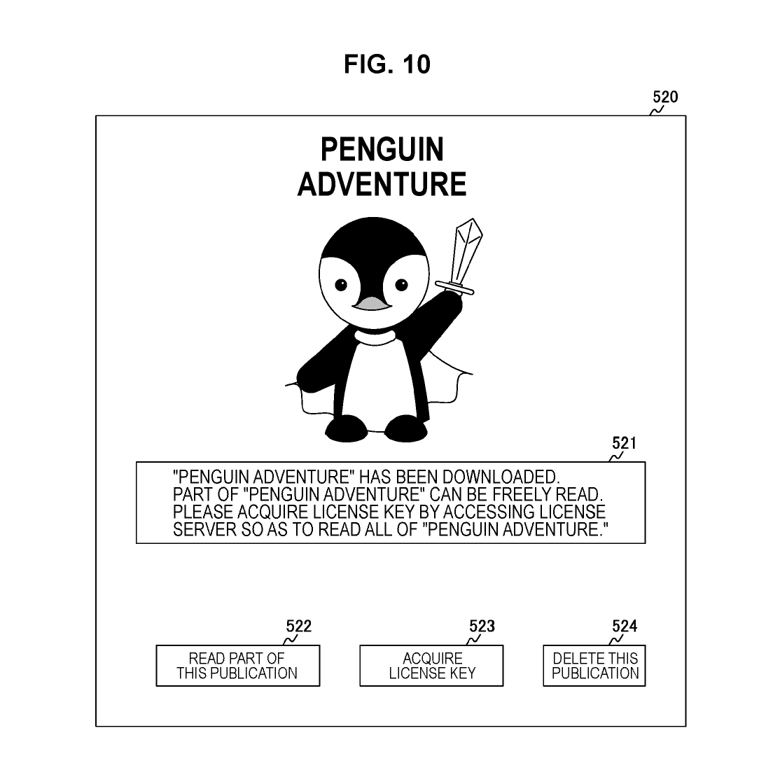

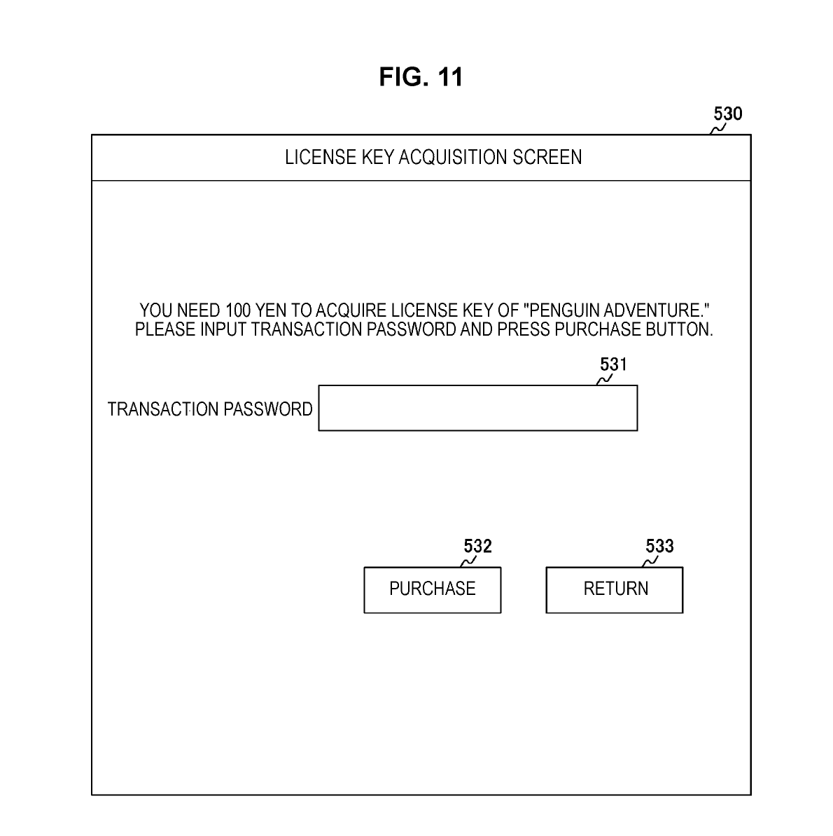

The display unit 450 is a display unit that displays various information (character information, time information, and the like) based on control of the control unit 430. The display unit 450, for example, displays information (for example, display screens illustrated in FIGS. 10 and 11) related to the acquisition of content. Also, for example, a display panel such as an organic electro luminescence (EL) panel or a liquid crystal display (LCD) panel can be used as the display unit 450. Also, the operation reception unit 440 and the display unit 450 can be integrally configured using a touch panel for enabling the user to perform an operation input through contact with or proximity to a display surface with his/her finger.

The storage unit 460 is a memory storing various information (for example, content and its license key). For example, a dedicated memory for storing content may be used as the storage unit 460.

[Example of Acquisition of Content Whose Use is Restricted]

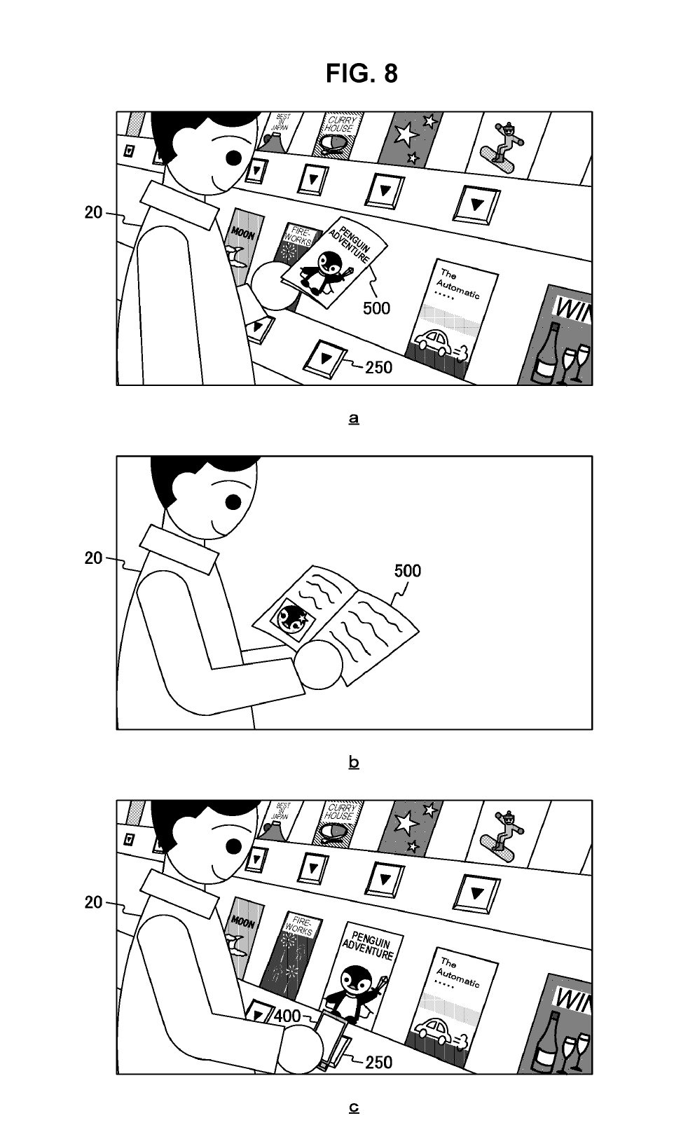

FIG. 8 is a simplified diagram illustrating an example of transition of acquisition when content (content whose use is restricted) is acquired using the wireless communication apparatus 400 in the first embodiment of the present technology.

In FIG. 8, an example in which a user 20 of the wireless communication apparatus 400 acquires electronic publication content of publications 500 while actually viewing the publication 500 in which the user is interested within a bookstore in which publications such as magazines are aligned and arranged is illustrated.

In FIG. 8a, a state in which the user 20 holds the publication 500 in which he/she is interested is illustrated.

Here, as illustrated in FIG. 8a, a touch point (indicated by a rectangle in which ▾ is added) to be used when publication content is acquired is installed below an installation portion of a corresponding publication on a bookshelf on which publications such as magazines are aligned and arranged. For example, below the installation portion of the publication 500, a touch point 250 to be used when the electronic publication content of the publication 500 is acquired is arranged.

Also, the touch point may be arranged for each type of publication as illustrated in FIG. 8. One touch point may be arranged for a plurality of types of publications. As described above, when one touch button is arranged for a plurality of types of publications, for example, one touch point can be provided for each bookshelf of each category (for example, a bookshelf of a library). In addition, in this case, an operation unit for selecting a desired publication from among a plurality of types of publications is set to be installed on a bookshelf or in the vicinity thereof. Alternatively, a selection operation for selecting a desired publication using a wireless communication apparatus owned by the user is performed. Selection information related to the selection operation may be included in the trial reading request (illustrated in FIG. 14) and transmitted to the content server 200.

In FIG. 8b, a state in which the user 20 is browsing the publication 500 he/she is holding is illustrated. As described above, the user can go to a bookstore and check contents of the publication 500 in which he/she is interested through a paper medium.

In FIG. 8c, a state in which the user 20 causes the wireless communication apparatus 400 to be in proximity to the touch point 250 to acquire content of the browsed publication 500 is illustrated. As described above, the content of the browsed publication 500 can be easily downloaded to the wireless communication apparatus 400 by causing the wireless communication apparatus 400 to be in proximity to the touch point 250. That is, while browsing the bookstore, the user can acquire the publication 500 in which he/she is interested in the bookstore through an electronic medium (electronic publication content). A flow of data upon the acquisition is illustrated in FIG. 9.

FIG. 9 is a simplified diagram illustrating a data flow upon acquisition when content (content whose use is restricted) is acquired using the wireless communication apparatus 400 in the first embodiment of the present technology.

In FIG. 9, a state in which content 510 and a trial reading key (first trial reading key 511) are transmitted from the content server 200 installed in the bookstore 10 to the wireless communication apparatus 400 is illustrated. Also, the content 510 is electronic publication content of the publication 500 illustrated in FIG. 8. In addition, in FIG. 9, the content 510 and the first trial reading key 511 are schematically shown by rectangles.

As described above, when the user 20 touches the touch point 250 with the wireless communication apparatus 400, the wireless communication apparatus 400 transmits a trial reading request to the content server 200. In this case, the trial reading request corresponding to an installation place of the touched touch point 250 is transmitted.

When the trial reading request is received, the content server 200 transmits content related to the received trial reading request and its trial reading key to the wireless communication apparatus 400. For example, as illustrated in FIG. 9, the content 510 and the first trial reading key 511 are transmitted to the wireless communication apparatus 400.

The content and its trial reading key transmitted as described above are recorded on the storage unit 460 of the wireless communication apparatus 400. Therefore, content stored in the storage unit 460 is displayed using the trial reading key. This display example is illustrated in FIG. 10.

[Example of Display Upon Acquisition of Content Whose Use is Restricted]

FIG. 10 is a diagram illustrating an example (a display screen 520) of a display screen displayed on the display unit 450 in the first embodiment of the present technology.

As illustrated in FIG. 9, the display screen 520 is a display screen to be displayed immediately after the content 510 and the first trial reading key 511 have been downloaded, and an image (for example, a cover of “Penguin Adventure”) corresponding to the downloaded content is displayed. In addition, on the display screen 520, a message display area 521, a button 522 for reading part of a publication, a button 523 for acquiring a license key, and a button 524 for deleting the publication are provided.

On the message display area 521, the fact that content corresponding to the touch point 250 in touch with the wireless communication apparatus 400 has been downloaded, the fact that part of the content can be freely read, or the like is displayed.

The button 522 for reading the part of the publication is a button to be pressed when part of the downloaded content is read. For example, when the button 522 for reading the part of the publication has been pressed, the part of the downloaded content is decoded and displayed using a simultaneously downloaded trial reading key. Thereby, the user can freely read part of a downloaded electronic publication.

The button 523 for acquiring the license key is a button to be pressed when all of the downloaded content is read. For example, when the button 523 for acquiring the license key has been pressed, a purchase request for acquiring the license key is transmitted to the license server 300. In addition, a display example after the button 523 for acquiring the license key has been pressed is illustrated in FIG. 11. For example, when the user freely performs trial reading of the part of the downloaded electronic publication and it is the publication in which the user is interested, the user can easily proceed to a procedure of purchasing the electronic publication by pressing the button 523 for acquiring the license key.

The button 524 for deleting the publication is a button to be pressed when the downloaded content is deleted. For example, when the button 524 for deleting the publication has been pressed, content stored in the storage unit 460 is deleted.

[Display Example of Operation Screen to be Used to Acquire License Key]

FIG. 11 is a diagram illustrating an example (a display screen 530) of a display screen displayed on the display unit 450 in the first embodiment of the present technology.

The display screen 530 is a display screen to be displayed immediately after the button 523 for acquiring the license key illustrated in FIG. 10 has been pressed. In addition, on the display screen 530, a transaction password input area 531, a purchase button 532, and a return button 533 are provided.

The transaction password input area 531 is an area for inputting a password to be used when transaction related to the purchase of a license key is performed. For example, a preset password is used in the wireless communication apparatus 400. Also, an input of a password may be omitted through a user setting.

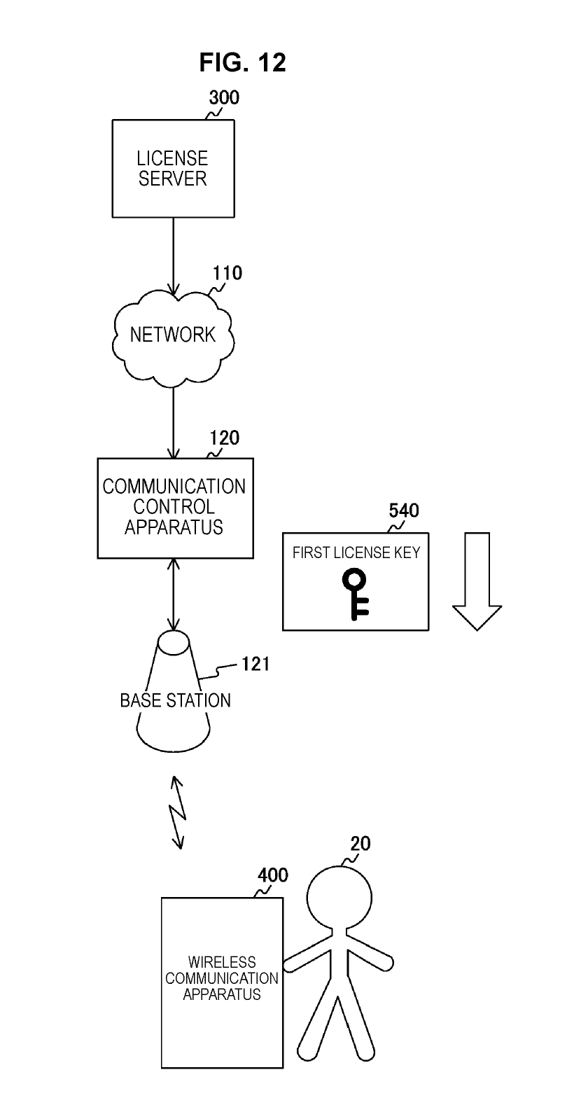

The purchase button 532 is a button to be pressed when the purchase of the license key is decided. For example, after the password has been input to the transaction password input area 531, the purchase button 532 is pressed. A flow of data upon acquisition of the license key after the press of the purchase button 532 is illustrated in FIG. 12.

The return button 533 is a button for returning to an immediately previous screen.

[Example of Acquisition of License Key]

FIG. 12 is a simplified example illustrating a flow of data upon acquisition when the license key is acquired using the wireless communication apparatus 400 in the first embodiment of the present technology.

In FIG. 12, a state in which a first license key 540 (a license key of the content 510 illustrated in FIG. 9) is transmitted from the license server 300 to the wireless communication apparatus 400 is illustrated. Also, the content 510 is electronic publication content of the publication 500 illustrated in FIG. 8. In addition, in FIG. 12, the first license key 540 is schematically illustrated by a rectangle as in FIG. 9.

For example, when the user 20 presses the purchase button 532 after inputting the password to the transaction password input area 531 illustrated in FIG. 11, the wireless communication apparatus 400 transmits a purchase request to the license server 300. In this case, a purchase request corresponding to the display screen 530 illustrated in FIG. 11 (that is, a purchase request for the license key of the content 510 illustrated in FIG. 9) is transmitted.

When the purchase request is received, the license server 300 performs an authentication process based on the received purchase request, and transmits the license key (first license key 540) corresponding to the purchase request to the wireless communication apparatus 400. Here, in the authentication process, as in a normal procedure of purchasing a product, each process for paying money for an electronic publication is performed. As described above, the purchase procedure for acquiring the license key can be similar to the normal product purchase procedure.

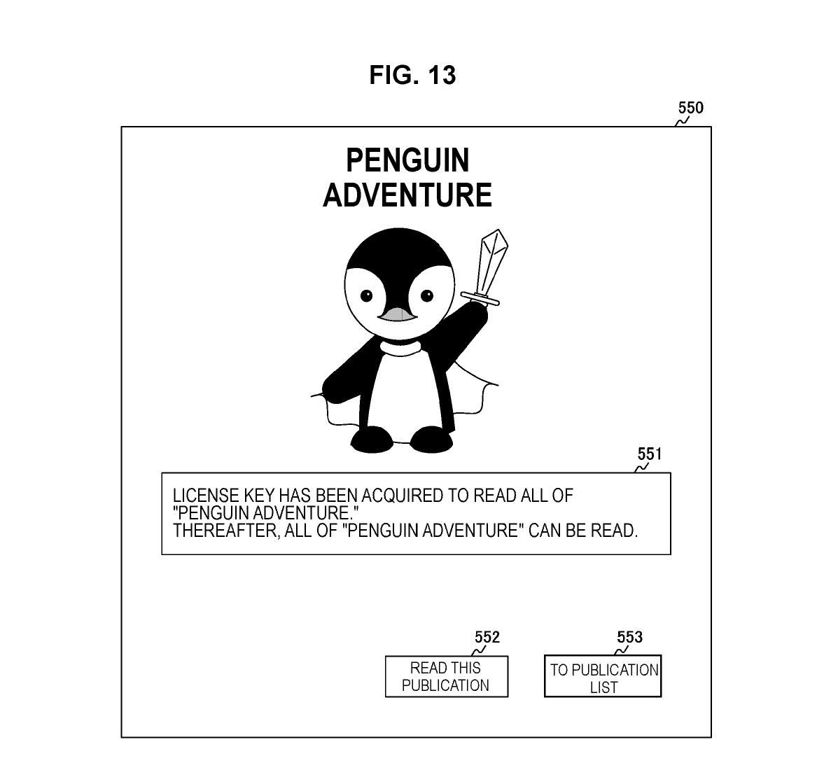

The first license key 540 transmitted as described above is stored in the storage unit 460 of the wireless communication apparatus 400. Therefore, all of the content 510 stored in the storage unit 460 can be displayed using the first license key 540. An example of a display upon acquisition of the first license key 540 is illustrated in FIG. 13.

[Example of Display Upon Acquisition of License Key]

FIG. 13 is a diagram illustrating an example (a display screen 550) of a display screen displayed on the display unit 450 in the first embodiment of the present technology.

The display screen 550 is a display screen to be displayed after the license key has been acquired by pressing the purchase button 532 illustrated in FIG. 11. In addition, on the display screen 550, a message display area 551, a button 552 for reading the publication, and a button 553 for a publication list are provided.

On the message display area 551, the fact that the license key has been acquired or the like is displayed.

The button 552 for reading the publication is a button to be pressed when downloaded content is read. For example, when the button 552 for reading the publication has been pressed, the downloaded content is decoded and displayed using the license key acquired through the purchase operation.

The button 553 for the publication list is a button to be pressed when the transition to a display screen for displaying a list for content stored in the storage unit 460 is made.

[Example of Communication Upon Acquisition of Content]

FIG. 14 is a sequence chart illustrating an example of a communication process between devices constituting an information processing system 100 in the first embodiment of the present technology. In FIG. 14, an example in which the user acquires content and a license key using the wireless communication apparatus 400 is illustrated. In addition, in this example, the case in which one touch point is installed for one publication will be assumed and described. Also, although the wireless communication apparatus 400 and the content server 200 are connected via the touch point 250, the illustration of the touch point 250 is omitted from FIG. 14 for ease of description.

Also, the wireless communication apparatus 400 is set to be connected to the license server 300 through wireless communication using a 3G network or wireless communication using a wireless local area network (LAN) (for example, wireless fidelity (Wi-Fi)). In addition, the wireless communication apparatus 400 may be connected to the license server 300 using near-field wireless communication (for example, TransferJet).

Initially, in order to acquire content of a browsed publication, the user causes the wireless communication apparatus 400 to be in proximity to the touch point. For example, as illustrated in FIG. 8c, the user 20 causes the wireless communication apparatus 400 to be in proximity to the touch point 250 so as to acquire the content 510 of the browsed publication 500.

As described above, near-field wireless communication between the wireless communication apparatus 400 and the touch point 250 is possible by causing the wireless communication apparatus 400 and the touch point 250 to be in proximity to each other. As described above, when the near-field wireless communication between the wireless communication apparatus 400 and the touch point 250 is possible, the control unit 430 of the wireless communication apparatus 400 transmits a trial reading request to the content server 200 via the touch point 250 (701 and 702). In this case, the control unit 240 of the content server 200 can select content related to the trial reading request according to the touch point 250 receiving the trial reading request. Also, when one touch point is installed for a plurality of publications, selection information for identifying user-selected content is transmitted to the content server 200 along with the trial reading request. Through the selection information, the control unit 240 of the content server 200 can select content related to the trial reading request.

When the trial reading request has been received (702), the control unit 240 of the content server 200 transmits content related to the received trial reading request and its trial reading key to the wireless communication apparatus 400 via the touch point 250 (703 and 704). For example, as illustrated in FIG. 9, the content 510 and its trial reading key (the first trial reading key 511) are downloaded to the wireless communication apparatus 400 (703 and 704).

Subsequently, the control unit 430 of the wireless communication apparatus 400 causes the received content and trial reading key to be stored in the storage unit 460 (705). Subsequently, the control unit 430 of the wireless communication apparatus 400 transmits a completion notification for notifying that the download of the content and its trial reading key has been completed to the content server 200 via the touch point (706 and 707).

Subsequently, the control unit 430 of the wireless communication apparatus 400 causes part of content newly recorded on the storage unit 460 to be displayed on the display unit 450 using the trial reading key (708). For example, the display screen 520 illustrated in FIG. 10 is displayed.

Next, an example in which the user performs a purchase operation in the wireless communication apparatus 400 so as to acquire a license key of content of a browsed publication is shown.

Initially, an operation (purchase operation) for acquiring a license key for displaying all of the content newly recorded on the storage unit 460 is performed (709). That is, an operation (purchase operation) for purchasing the downloaded content is performed (709). For example, when the button 523 for acquiring the license key is pressed in the display screen 520 illustrated in FIG. 10, the display screen 530 illustrated in FIG. 11 is displayed. Subsequently, after a password has been input to the transaction password input area 531 in the display screen 530, the purchase button 532 is pressed.

When the purchase operation has been performed (709), the control unit 430 of the wireless communication apparatus 400 transmits the purchase request for purchasing the license key to the license server 300 (710 and 711). For example, the purchase request is transmitted to the license server 300 using the 3G network (710 and 711). In addition, this purchase request includes content identification information for identifying content.

When the purchase request has been received (711), the control unit 340 of the license server 300 performs an authentication process on the received purchase request (712). In this authentication process, each process for paying money for an electronic publication is performed as described above. Therefore, when authentication has failed (for example, when it is difficult to pay money for the electronic publication), an error is transmitted to the wireless communication apparatus 400.

In addition, when the authentication has passed (712), the control unit 340 of the license server 300 extracts a license key which is stored in the license key management DB 320 and in association with content identification information included in the purchase request. Therefore, the control unit 340 of the license server 300 transmits the extracted license key (a license key of content related to the purchase request) to the wireless communication apparatus 400 (713 and 714). For example, when content identification information “C001” is included in the purchase request, the first license key 540 is transmitted to the wireless communication apparatus 400 using the 3G network as illustrated in FIG. 12 (713 and 714). Also, when the wireless communication apparatus transmitting the purchase request is subjected to domain registration, its domain information is recorded on the domain information 324 of the license key management DB 320.

Subsequently, the control unit 430 of the wireless communication apparatus 400 causes the received license key to be recorded on the storage unit 460 (715).

Subsequently, the control unit 430 of the wireless communication apparatus 400 transmits a completion notification for notifying that the download of the license key has been completed to the license server 300 (716 and 717). For example, the completion notification is transmitted to the license server 300 using the 3G network (716 and 717).

Subsequently, the control unit 430 of the wireless communication apparatus 400 causes all of the content recorded on the storage unit 460 to be displayed on the display unit 450 using the license key (718). For example, the display screen 550 illustrated in FIG. 13 is displayed.

[Operation Example of Content Server]

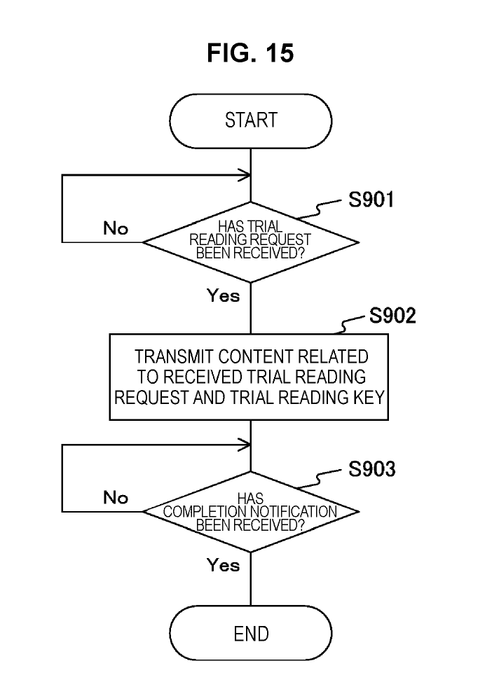

FIG. 15 is a flowchart illustrating an example of a processing procedure of a content transmission process by the content server 200 in the first embodiment of the present technology.

Initially, the control unit 240 determines whether a trial reading request has been received via the touch point (step S901), and continues monitoring when the trial reading request has not been received. On the other hand, when the trial reading request has been received (step S901), the control unit 240 transmits content related to the trial reading request and its trial reading key to the wireless communication apparatus via the touch point (step S902).

Subsequently, the control unit 240 determines whether a completion notification indicating that the download of the content and its trial reading key has been completed has been received via the touch point (step S903), and continues monitoring when no completion notification has been received. On the other hand, when the completion notification has been received (step S903), an operation of the content transmission process ends.

[Example of Operation of Wireless Communication Apparatus]

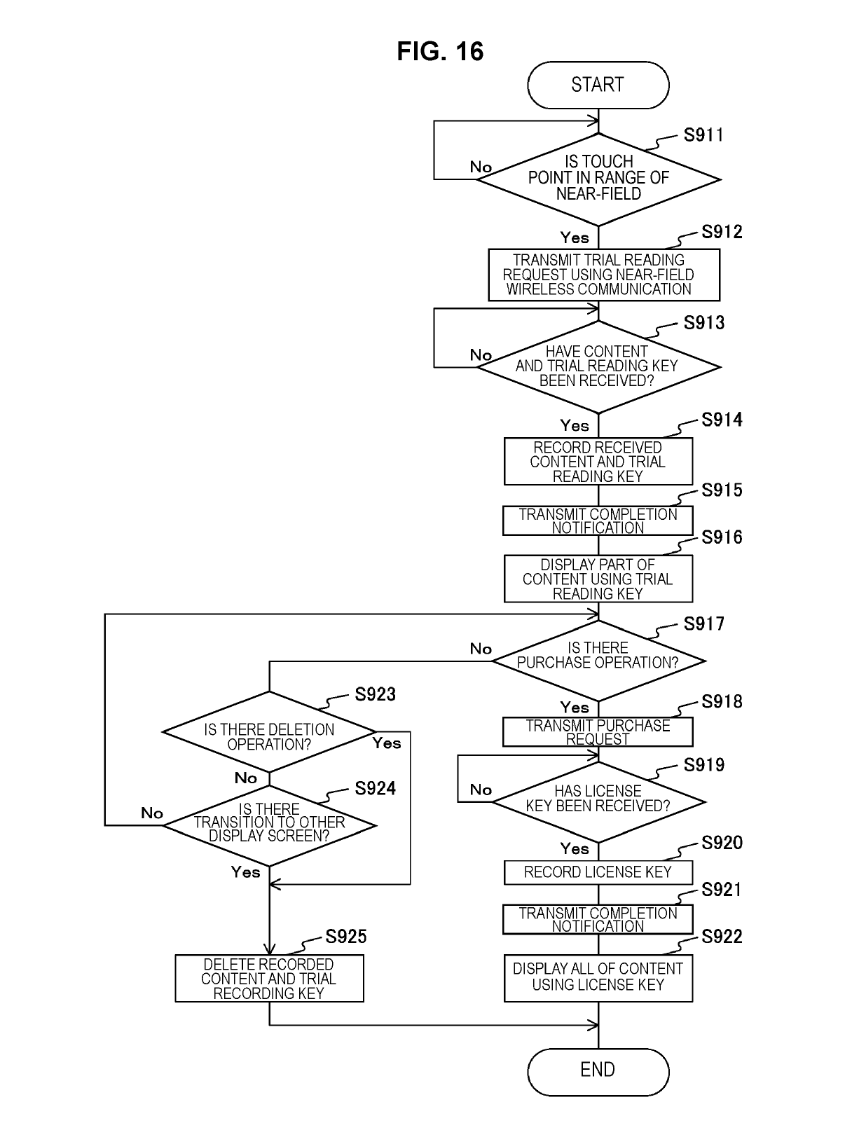

FIG. 16 is a flowchart illustrating an example of a processing procedure of a content acquisition process by the wireless communication apparatus 400 in the first embodiment of the present technology. In this processing procedure, an example in which the content and its trial reading key are deleted when no purchase operation is performed after part of the content has been displayed using the trial reading key is shown.

Initially, the control unit 430 determines whether there is a touch point in a range of near-field wireless communication (step S911), and continues monitoring when there is no touch point in the range of the near-field wireless communication. On the other hand, when there is a touch point in the range of the near-field wireless communication (step S911), the control unit 430 transmits the trial reading request to the content server 200 via the touch point using the near-field wireless communication (step S912).

Subsequently, the control unit 430 determines whether content and its trial reading key have been received (step S913), and continues monitoring when the content and its trial reading key have not been received. On the other hand, when the content and its trial reading key have been received (step S913), the control unit 430 causes the received content and trial reading key to be recorded on the storage unit 460 (step S914). Subsequently, the control unit 430 transmits a completion notification for notifying that the download of the content and its trial reading key has been completed to the content server 200 via the touch point (step S915).

Subsequently, the control unit 430 causes the display unit 450 to display part of content newly recorded on the storage unit 460 using its trial reading key (step S916).

Subsequently, the control unit 430 determines whether an operation (purchase operation) for acquiring a license key for displaying all of the content newly recorded on the storage unit 460 has been performed (step S917). When the purchase operation has been performed (step S917), the control unit 430 transmits the purchase request for purchasing the license key to the license server 300 (step S918).

Subsequently, the control unit 430 determines whether the license key has been received (step S919), and continues monitoring when no license key has been received. On the other hand, when the license key has been received (step S919), the control unit 430 causes the storage unit 460 to record the received license key (step S920). Subsequently, the control unit 430 transmits a completion notification for notifying that the download of the license key has been completed to the license server 300 (step S921).

Subsequently, the control unit 430 causes the display unit 450 to display all of the content recorded on the storage unit 460 using its license key (step S922).

In addition, when no purchase operation has been performed (step S917), the control unit 430 determines whether a deletion operation for deleting content newly recorded on the storage unit 460 has been performed (step S923). Therefore, when the deletion operation has been performed (step 923), the process proceeds to step S925. On the other hand, when no deletion operation has been performed (step S923), the control unit 430 determines whether the transition to a display screen other than the display screen for displaying content newly recorded on the storage unit 460 has been made (step S924). When the transition to another display screen has not been made (step S924), the process returns to step S917. On the other hand, when the transition to the other display screen has been made (step S924), the control unit 430 deletes the content and its trial reading key newly recorded on the storage unit 460 from the storage unit 460 (step S925).

In this example, an example in which content and its trial reading key are deleted when no purchase operation is performed after part of the content has been displayed using the trial reading key has been shown. However, for example, a user who desires to display and check part of the content after merely downloading content and its trial reading key in a bookstore and returning home is also assumed. Therefore, the content and its trial reading key may be deleted after the passage of a predetermined time (for example, after the passage of 12 hours) without being deleted immediately after a display in the bookstore. In addition, when content has exceeded a predetermined size of the storage unit 460, the content may be sequentially deleted beginning with old content. In addition, the timing of deletion may be set according to the user's operation.

[Example in which Accompanying Information is Simultaneously Transmitted]

An example in which content and its trial reading key are simultaneously provided to the wireless communication apparatus according to a trial reading request has been shown above. That is, an example in which only content intended by the user is provided to the wireless communication apparatus has been shown.

Here, for example, when TransferJet is used as near-field wireless communication, a communication speed is very fast as compared to other near-field wireless communication (for example, a wireless LAN or Bluetooth (registered trademark)). Thus, the time burden is considered to be absent even when other information (recommended content) is simultaneously transmitted in addition to user-intended content. Therefore, an example in which the other information (accompanying information) is simultaneously transmitted in addition to the user-intended content is shown hereinafter. Thereby, when the user considers the purchase of an electronic publication, it is possible to recommend other electronic publications or associated information together and to promote the user's willingness to purchase. In addition, it is possible to provide various information to users and increase sales opportunities for a bookstore.

[Example of Acquisition of Content Whose Use is Restricted]

FIG. 17 is a simplified diagram illustrating a flow of data upon acquisition when content (content whose use is restricted) is acquired using the wireless communication apparatus 400 in the first embodiment of the present technology. The example illustrated in FIG. 17 is a modified example of FIG. 9, and is different in that accompanying information 560 has been added. Thus, parts common with FIG. 9 are denoted by the same reference signs and part of description thereof is omitted.

As described above, when the user 20 touches the touch point 250 with the wireless communication apparatus 400, the wireless communication apparatus 400 transmits a trial reading request to the content server 200. In this case, a trial reading request corresponding to an installation place of the touched touch point 250 is transmitted.

When the trial reading request is received, the content server 200 transmits accompanying information to the wireless communication apparatus 400 along with content related to the received trial reading request and its trial reading key. For example, as illustrated in FIG. 17, the content 510, the first trial reading key 511, and the accompanying information 560 are transmitted to the wireless communication apparatus 400.

Here, the accompanying information is information associated with content related to the received trial reading request. For example, information associated with the content related to the trial reading request among information stored in the accompanying information 234 illustrated in FIG. 3 is transmitted as the accompanying information.

The content, its trial reading key, and the accompanying information transmitted as described above are recorded on the storage unit 460 of the wireless communication apparatus 400. Therefore, the content stored in the storage unit 460 is displayed using its trial reading key. In addition, the accompanying information stored in the storage unit 460 is also displayed. This display example is illustrated in FIG. 18.

[Example of Display Upon Acquisition of Accompanying Information]

FIG. 18 is a diagram illustrating an example (a display screen 570) of a display screen displayed on the display unit 450 in the first embodiment of the present technology.

The display screen 570 is a display screen to be displayed immediately after the content 510, the first trial reading key 511, and the accompanying information 560 illustrated in FIG. 17 have been downloaded, and an image (for example, a cover of “Penguin Adventure”) corresponding to the downloaded content is displayed. In addition, each image related to the downloaded accompanying information is displayed on the display screen 570.

For example, when content (for example, content 561 and 563 illustrated in FIG. 17) associated with content related to the trial reading request has been downloaded as the accompanying information, images (for example, content image display areas 573 and 574) representing the content are displayed.

On the display screen 570, a message display area 571, content image display areas 572 to 574, a button 575 for reading part of the publication, a button 576 for acquiring the license key, and a button 577 for deleting the publication are provided.

On the message display area 571, a notification indicating that content and accompanying information corresponding to the touch point 250 in touch with the wireless communication apparatus 400 have been downloaded, a notification indicating that part of the content can be freely read, or the like is displayed.

In the content image display areas 572 to 574, there is an area for displaying an image representing downloaded content (including content downloaded as accompanying information). For example, it is possible to perform an operation related to content set to a selected state by setting one image among images displayed on the content image display areas 572 to 574 to the selected state and performing an operation of each of buttons 575 to 577. In FIG. 18, an image (an image of content related to the trial reading request) displayed on the content image display area 572 is assumed to be set to the selected state.

The button 575 for reading the part of the publication, the button 576 for acquiring the license key, and the button 577 for deleting the publication correspond to the buttons having the same names illustrated in FIG. 10. In this example, in the content image display areas 572 to 574, an operation related to content set to the selected state is however assumed to be performed.

Also, based on an analysis result of a preference of the user, information in which each user may be interested may be selected and used as accompanying information. For example, the preference of the user is analyzed using a sales history (for example, a sales history of members) in the bookstore and its analysis result can be used.

In addition, for example, as one of recommendations, a back issue of a browsed publication, and an advertisement (a publication, an event, a product, or the like) of the browsed publication according to an age or preference can be transmitted as accompanying information. For example, when the browsed publication is a fashion magazine, a coupon of a shop published in the fashion magazine can be set as the accompanying information. In addition, for example, when the browsed publication is a novel, an advertisement of a movie or TV drama of the novel can be set as the accompanying information. This display example is illustrated in FIG. 19.

In addition, an advertisement associated with the vicinity of the bookstore in which browsing has been performed (a restaurant located in the vicinity of the bookstore and the like) can be set as the accompanying information. In this case, for example, contents of an advertisement may be changed according to a time band. For example, a lunch coupon can be set as the accompanying information in a lunch time band, and a dinner coupon can be set as the accompanying information in a night time band. This display example is illustrated in FIG. 20.

In addition, a questionnaire (for example, corresponding to a questionnaire postcard stuck in a publication of a paper medium) can be set as the accompanying information. A service related to the questionnaire may be provided for a user responding to the questionnaire.

In addition, as accompanying information to be transmitted along with content and its trial reading key, a piece (for example, an application (app) or image (standby screen)) whose use is restricted may be transmitted. On the condition that content has been purchased, the use restriction of the accompanying information may be released. For example, when the license key is purchased, the license server 300 can transmit information for releasing the use of the accompanying information to the wireless communication apparatus along with the license key.

For example, when the browsed publication is a publication in a campaign, an app associated with the publication may be set as the accompanying information (accompanying information whose use is restricted). Therefore, when the publication in the campaign has been purchased, the use restriction of the app may be released. For example, when a publication of “cartoon OO” in a campaign is purchased, a game app or a theme setting app of “cartoon OO” can be presented.

In addition, when the browsed publication is a publication for health, a health management app may be set as the accompanying information (accompanying information whose use has been restricted). When the publication for health has been purchased, the use restriction of the health management app may be released.

In addition, when the browsed publication is a photo collection, a standby screen of an image of part (for example, one page) of the photo collection may be set as the accompanying information. In addition, when the photo collection has been purchased, standby screens of images of parts (for example, five pages) of the photo collection may be set to be available.

In addition, when the browsed publication is an instructional publication, an app associated with the instructional publication may be set as the accompanying information (accompanying information whose use has been restricted). In addition, when the instructional publication has been purchased, the use restriction of its app may be set to be released.

For example, when an English vocabulary publication has been purchased, an English vocabulary app may be set to be available instead of a compact disc (CD) of English vocabulary. In addition, for example, when an architectural publication has been purchased, a room layout creation app may be set to be available. In addition, for example, when a travel publication has been purchased, a regional map or shop app described in the travel publication may be set to be available.

In addition, for example, when a novel or a picture book has been purchased, sound data of storytelling may be set to be available. In addition, for example, when a publication on a singer has been purchased, music data corresponding to one of the singer's songs may be set to be available. In addition, for example, when a book that has been adapted to film has been purchased, a discount ticket for the film may be set to be available.

In addition, accompanying information may be changed according to a user's state. For example, the user may change accompanying information according to a bookstore in which download was performed (Where), an identity of the user (Who), a time at which the download was performed (When), and what was downloaded (What). For example, the control unit 240 of the content server 200 can determine accompanying information (for example, a coupon related to a neighboring restaurant) according to a place of the wireless communication apparatus transmitting a trial reading request. In addition, the control unit 240 can determine accompanying information (for example, a coupon of a fashion magazine for women in their twenties) according to the user of the wireless communication apparatus (for example, his/her attributes (for example, sex and age)). In addition, the control unit 240 can determine accompanying information (for example, a coupon of a heating appliance in the winter) according to a date (for example, a time slot and a season) on which the trial reading request was transmitted. In addition, the control unit 240 can determine accompanying information (for example, publications by the same novelist) according to contents (for example, a novel and a fashion magazine) of content related to the trial reading request. In addition, accompanying information (for example, a coupon for a ski resort for men in their twenties in the winter) may be determined according to their combination.

As described above, the control unit 240 can determine accompanying information based on at least one of the location of the wireless communication apparatus transmitting the trial reading request, the user of the wireless communication apparatus, the date on which the trial reading request was transmitted, and the contents of the content related to the trial reading request.

[Example of Display Upon Acquisition of Accompanying Information]

FIGS. 19 and 20 are diagrams illustrating examples (display screens 580 and 590) of display screens displayed on the display unit 450 in the first embodiment of the present technology.

The display screens 580 and 590 are modifications of part of the display screen 570 illustrated in FIG. 18, contents of message display areas 581 and 591 are changed, and accompanying information display areas 582 and 592 are provided instead of the content image display areas 572 to 574. Also, other details are similar to those of the example illustrated in FIG. 18.

In FIG. 19, an example in which an advertisement of the downloaded “Penguin Adventure” is set as the accompanying information is illustrated. For example, when “Penguin Adventure” has been adapted to film, a discount coupon for the film can be set as accompanying information as illustrated in FIG. 19.

In FIG. 20, an example in which an advertisement associated with the vicinity of the bookstore in which content has been downloaded is set as the accompanying information is illustrated. For example, when content has been downloaded in a lunch time slot, a lunch coupon can be set as accompanying information as illustrated in FIG. 20.

[Example in which Touch Point Transmits Trial Reading Request]

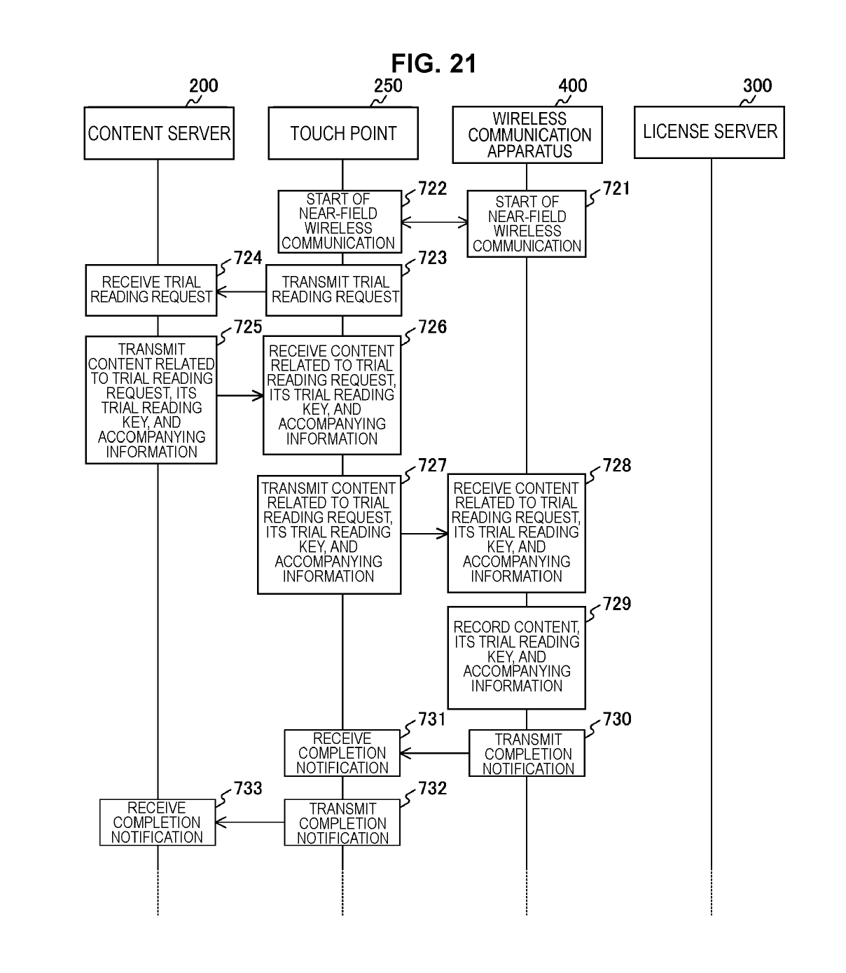

An example in which the wireless communication apparatus transmits the trial reading request has been shown above. Here, for example, the touch point, which performs near-field wireless communication with the wireless communication apparatus, may transmit the trial reading request to the content server. In FIG. 21, an example in which the touch point transmits the trial reading request to the content server is illustrated.

[Example of Communication Upon Acquisition of Content]

FIG. 21 is a sequence chart illustrating an example of a communication process between devices constituting the information processing system 100 in the first embodiment of the present technology. In FIG. 21, an example in which the touch point 250 transmits the trial reading request to the content server 200 is illustrated. In addition, in this example, the case in which one touch point is installed for one publication will be assumed and described. Also, because processes after transmission and reception (730 to 733) of a completion notification are similar to the processes 708 to 718 illustrated in FIG. 14, the illustration and description thereof are omitted here. In addition, in FIG. 21, an example in which accompanying information is transmitted along with content and its trial reading key is illustrated.

Initially, the user causes the wireless communication apparatus 400 to be in proximity to the touch point 250 so as to acquire content of a browsed publication. For example, as illustrated in FIG. 8c, the user 20 causes the wireless communication apparatus 400 to be in proximity to the touch point 250 so as to acquire the content 510 of the browsed publication 500.

As described above, near-field wireless communication between the wireless communication apparatus 400 and the touch point 250 is started by causing the wireless communication apparatus 400 and the touch point 250 to be in proximity to each other (721 and 722). As described above, when the near-field wireless communication between the wireless communication apparatus 400 and the touch point 250 is started, the touch point 250 transmits a trial reading request to the content server 200 (723 and 724). In this case, the control unit 240 of the content server 200 can select content related to the trial reading request according to the touch point 250 transmitting the trial reading request. Also, when one touch point is installed for a plurality of publications, the touch point 250 receives selection information for identifying user-selected content, includes the selection information in the trial reading request, and transmits the selection information included in the trial reading request to the content server 200. Through the selection information, the control unit 240 of the content server 200 can select content related to the trial reading request.

When the trial reading request has been received (724), the control unit 240 of the content server 200 transmits content related to the received trial reading request, its trial reading key, and the accompanying information to the wireless communication apparatus 400 via the touch point 250 (725 to 728). For example, as illustrated in FIG. 17, the content 510, its trial reading key (the first trial reading key 511), and the accompanying information 560 are downloaded to the wireless communication apparatus 400 (725 to 728).

Subsequently, the control unit 430 of the wireless communication apparatus 400 causes the received content, trial reading key, and accompanying information to be stored in the storage unit 460 (729). Subsequently, the control unit 430 of the wireless communication apparatus 400 transmits a completion notification for notifying that the download of the content, its trial reading key, and the accompanying information has been completed to the content server 200 via the touch point 250 (730 to 733).

As described above, the communication unit 210 of the content server 200 receives an acquisition request for content that occurs according to near-field wireless communication to be performed by the wireless communication apparatus 400. In addition, the control unit 240 of the content server 200 controls transmission of content (content whose use is restricted) related to the received acquisition request and accompanying information associated therewith to the wireless communication apparatus 400. In addition, the acquisition request is output from any one of the wireless communication apparatus 400 and the touch point 250 according to a timing at which near-field wireless communication began between the wireless communication apparatus 400 and the touch point 250.

[Example in which Touch Point Includes Function of Content Server]

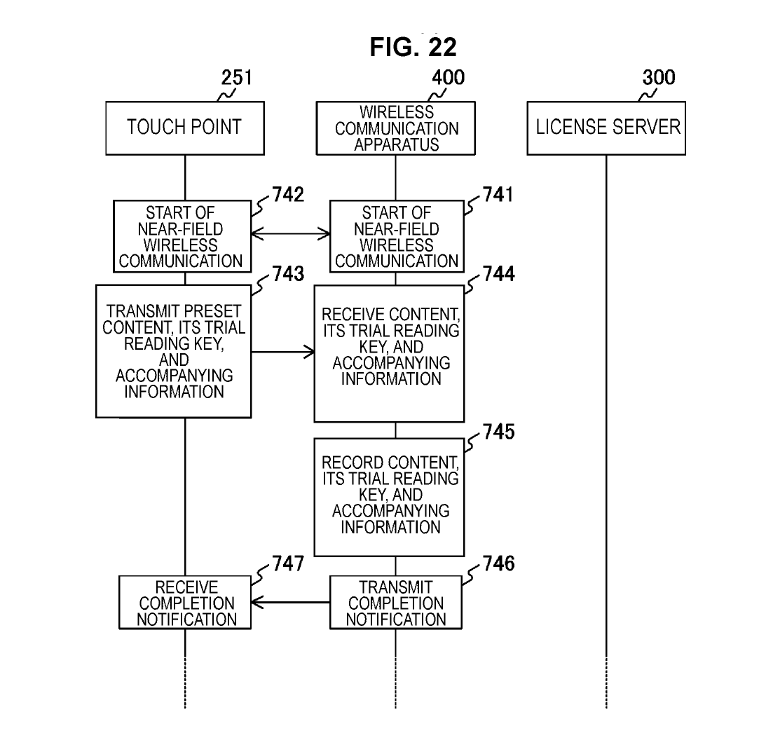

An example in which the content server transmits content to the wireless communication apparatus via the touch point has been shown above. Here, for example, when only the limited number of publications are provided as electronic publication content, a case in which the function of the content server is provided in the touch point and a simple electronic publication distribution system is set is also considered. In FIG. 22, an example in which the touch point has the function of the content server is illustrated.

[Example of Communication Upon Acquisition of Content]

FIG. 22 is a sequence chart illustrating an example of a communication process between devices constituting the information processing system 100 in the first embodiment of the present technology. In FIG. 22, an example in which a touch point 251 has a function of the content server 200 and the content server 200 is omitted is illustrated. In addition, in this example, the case in which one touch point is installed for one publication will be assumed and described. Also, because processes after transmission and reception (746 and 747) of a completion notification are similar to the processes (708 to 718) illustrated in FIG. 14, the illustration and description thereof are omitted here. In addition, in FIG. 22, an example in which accompanying information is transmitted along with content and its trial reading key is illustrated.

Here, the touch point 251 is a modification of part of the content server 200 illustrated in FIG. 2, and a near-field wireless communication unit is provided instead of the communication unit 210. Also, because other details are substantially similar to those of the content server 200 illustrated in FIG. 2, the illustration and description thereof are omitted here.

Initially, the user causes the wireless communication apparatus 400 to be in proximity to the touch point 251 so as to acquire content of a browsed publication. For example, as illustrated in FIG. 8c, the user 20 causes the wireless communication apparatus 400 to be in proximity to the touch point 251 so as to acquire the content 510 of the browsed publication 500.

As described above, near-field wireless communication between the wireless communication apparatus 400 and the touch point 251 is started by causing the wireless communication apparatus 400 and the touch point 251 to be in proximity to each other (741 and 742). As described above, when the near-field wireless communication has begun, the near-field wireless communication unit of the touch point 251 receives the trial reading request that occurs according to a timing at which the near-field wireless communication began. Therefore, the control unit (corresponding to the control unit 240 of the content server 200) of the touch point 251 transmits preset content, its trial reading key, and accompanying information to the wireless communication apparatus 400 (743 and 744). Also, when one touch point is installed for a plurality of publications, the content, its trial reading key, and the accompanying information are determined and transmitted based on selection information for identifying user-selected content.

Subsequently, the control unit 430 of the wireless communication apparatus 400 causes the received content, trial reading key, and accompanying information to be stored in the storage unit 460 (745). Subsequently, the control unit 430 of the wireless communication apparatus 400 transmits a completion notification for notifying that the download of the content, its trial reading key, and the accompanying information has been completed to the touch point 251 (746 and 747).

As described above, the near-field wireless communication unit of the touch point 251 receives an acquisition request for content that occurs according to near-field wireless communication to be performed by the wireless communication apparatus 400.

In addition, the control unit of the touch point 251 (corresponding to the control unit 240 of the content server 200) controls transmission of content (content whose use is restricted) related to the received acquisition request and accompanying information associated therewith to the wireless communication apparatus 400. In addition, the acquisition request is received according to a timing at which near-field wireless communication with the wireless communication apparatus 400 began.

As described above, in accordance with the first embodiment of the present technology, user-desired content can be easily acquired using an electronic data distribution system using proximity wireless communication technology to be used by making proximity or contact. In this case, because part of content can be freely viewed, it is possible to easily check whether to actually purchase the content according to a display of part of the content.

In addition, content associated with the user-desired content can also be simultaneously acquired. In addition, because part of the above-described content can also be freely viewed, it is possible to easily check whether to actually purchase the content according to a display of part of the content.

In addition, appropriate accompanying information can be provided to the user every time the user downloads content. That is, content and accompanying information associated therewith can be appropriately provided.

As described above, in the first embodiment of the present technology, it is possible to improve convenience for the user, improve the ability to attract customers for a bookstore, and improve convenience for both the sides by combining near-field wireless communication with the electronic publication distribution system.

### 2. Second Embodiment

In the first embodiment of the present technology, an example in which accompanying information is provided to the wireless communication apparatus along with content related to a trial reading request and its trial reading key has been shown. However, there are also assumed to be users who prefer not to store large amounts of unintended information in the memory of the wireless communication apparatus.

Therefore, in the second embodiment of the present technology, an example in which accompanying information is provided to the wireless communication apparatus according to a user-set capacity is shown. Also, the configuration of the information processing system in the second embodiment of the present technology is approximately the same as that of the example illustrated in FIG. 1, 2, or the like. Thus, parts common with those of the first embodiment of the present technology are denoted by the same reference signs, and the description thereof is partially omitted.

[Example of Storage Unit]

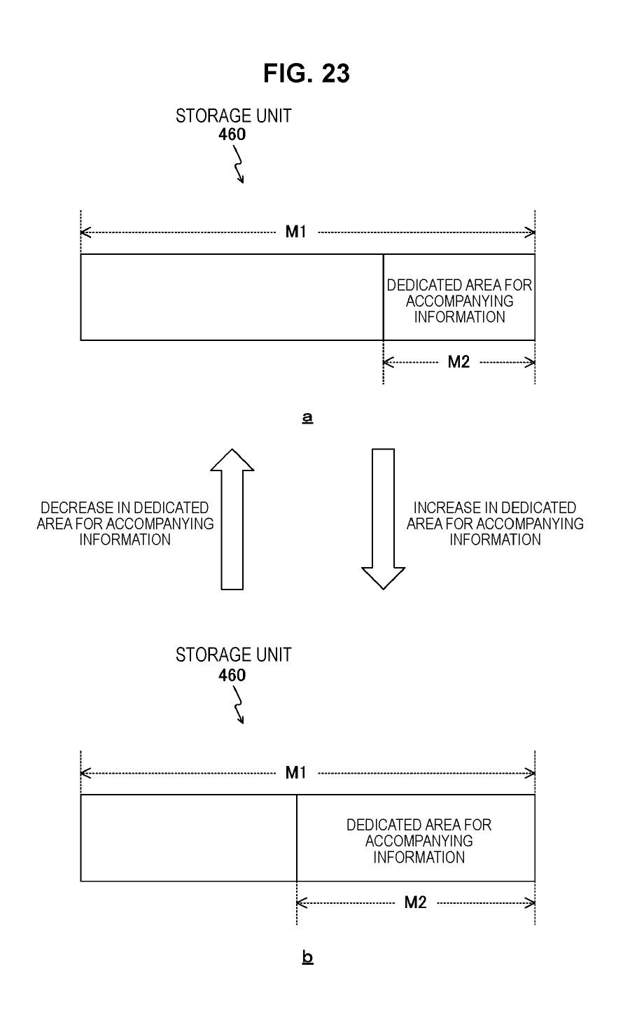

FIG. 23 is a diagram schematically illustrating an example of a memory capacity of the storage unit 460 in the second embodiment of the present technology.

In FIG. 23, an example in which a dedicated area (a dedicated area for accompanying information) for storing the accompanying information is provided in the storage unit 460 is illustrated. In addition, M1 is set to represent a total memory capacity of the storage unit 460, and M2 is set to represent a memory capacity of a dedicated area for the accompanying information in the storage unit 460.

Here, the dedicated area for the accompanying information in the storage unit 460 is set to be increased or decreased according to the user's operation. In FIG. 23a, a state in which the dedicated area for the accompanying information in the storage unit 460 has been decreased is illustrated. In FIG. 23b, a state in which the dedicated area for the accompanying information in the storage unit 460 has been increased is illustrated.

In addition, for data to be written to the dedicated area for the accompanying information in the storage unit 460, a setting indicating that only overwriting is performed is assumed to be made according to the user's operation.

[Example of Operation of Content Server]

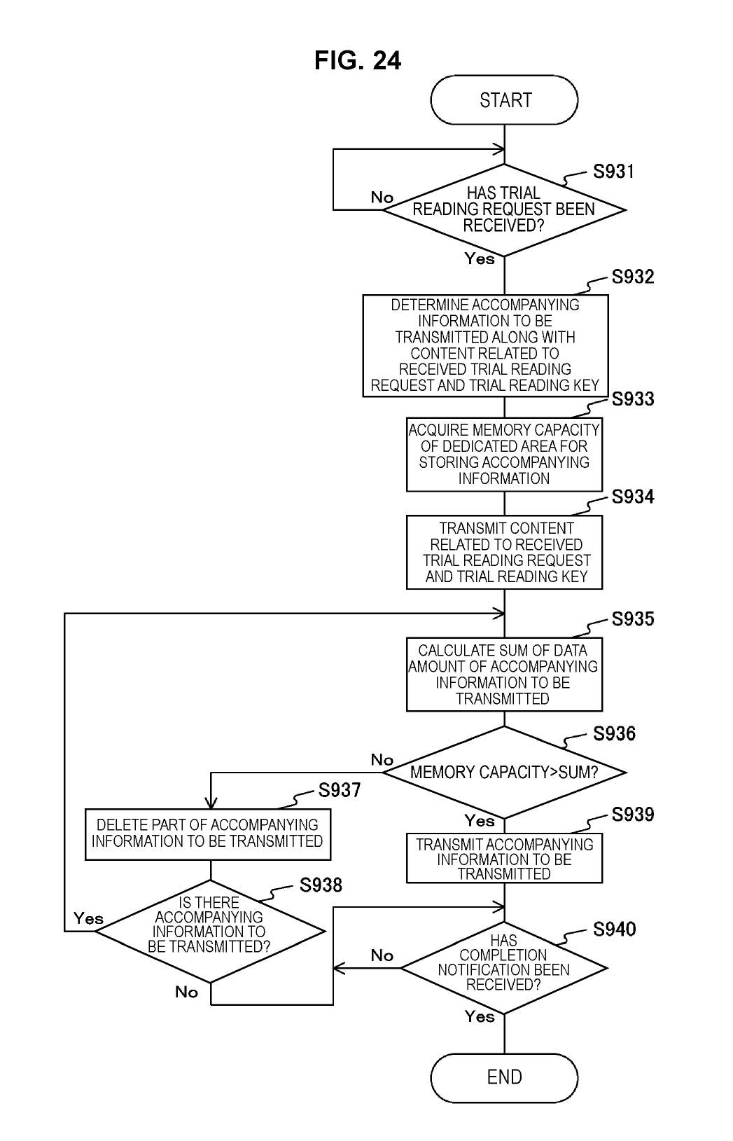

FIG. 24 is a flowchart illustrating an example of a processing procedure of a content transmission process by the content server 200 in the second embodiment of the present technology.

Initially, the control unit 240 determines whether the trial reading request has been received via the touch point (step S931), and continues monitoring when no trial reading request has been received. On the other hand, when the trial reading request has been received (step S931), the control unit 240 determines accompanying information to be transmitted along with content related to the trial reading request and its trial reading key (step S932). For example, the determination is made from among information (information associated with the content related to the trial reading request) stored in the accompanying information 234 illustrated in FIG. 3. In this example, content in which content identification information is stored in recommended content identification information of the accompanying information 234 illustrated in FIG. 3 and its trial reading key are assumed to be determined as accompanying information.

Subsequently, the control unit 240 acquires a memory capacity (for example, Memory Capacity=MX is set) of the dedicated area (the dedicated area for the accompanying information) for storing the accompanying information using near-field wireless communication from the wireless communication apparatus transmitting the trial reading request (step S933). For example, the memory capacity M2 of the dedicated area for the accompanying information in the storage unit 460 illustrated in FIG. 23 is transmitted from the wireless communication apparatus 400 to the content server 200 via the touch point.

Subsequently, the control unit 240 transmits the content related to the trial reading request and its trial reading key to the wireless communication apparatus via the touch point (step S934).

Subsequently, the control unit 240 calculates a sum of a data amount of accompanying information serving as an object to be transmitted (step S935). For example, the case in which content “C002” and “C003” in which content identification information is stored in recommended content identification information of the accompanying information 234 illustrated in FIG. 3 and their trial reading keys are set as accompanying information is assumed. In this case, a data size of second content (content identification information “C002”) and its trial reading key is set as BX and a data size of third content (content identification information “C003”) and its trial reading key is set as CX. In this case, “BX+CX” is calculated as the sum of the data amount of the accompanying information serving as the object to be transmitted (step S935).

Subsequently, the control unit 240 compares the acquired memory capacity MX to the sum BX+CX of the data amount of the accompanying information serving as the object to be transmitted and determines whether the memory capacity MX is greater than the sum BX+CX (step S936). Therefore, when the memory capacity MX is less than the sum BX+CX (step S936), the control unit 240 deletes part of the accompanying information serving as the object to be transmitted (step S937). For example, when the accompanying information serving as the object to be transmitted is the second content (content identification information “C002”) and its trial reading key and the third content (content identification information “C003”) and its trial reading key, any one is deleted. For example, deletion may be performed from higher-order content in an order determined in advance, and deletion may be performed from content having a large data size.

Subsequently, the control unit 240 determines whether there is accompanying information of the object to be transmitted (step S938), and the process proceeds to step S940 when there is no accompanying information of the object to be transmitted. For example, when all of the accompanying information of the object to be transmitted has been deleted according to the deletion of the accompanying information, the process proceeds to step S940. On the other hand, when there is accompanying information of the object to be transmitted (step S938), the process returns to step S935. The sum of the data amount of the accompanying information is calculated after part has been deleted (step S935).

In addition, when the memory capacity MX is greater than the sum BX+CX (step S936), the control unit 240 transmits the accompanying information of the object to be transmitted to the wireless communication apparatus via the touch point (step S939).

Subsequently, the control unit 240 determines whether a completion notification indicating that download of content and its trial reading key has been completed has been received via the touch point (step S940), and continues monitoring when no completion notification has been received. On the other hand, when the completion notification has been received (step S940), an operation of the content transmission process ends. In addition, step S931 is an example of a procedure of receiving described in the claims. Also, steps S932 to S939 are an example of a procedure of controlling described in the claims.

As described above, the control unit 240 of the content server 200 transmits the accompanying information to the wireless communication apparatus and controls a dedicated memory set in the wireless communication apparatus to store the accompanying information. In this case, the control unit 240 of the content server 200 controls only the accompanying information corresponding to an allowable amount of the dedicated memory to be transmitted to the wireless communication apparatus.

As described above, in accordance with the second embodiment of the present technology, only accompanying information corresponding to the memory capacity of the dedicated area (the dedicated area for the accompanying information) for storing the accompanying information can be provided to the wireless communication apparatus. Thereby, the user can prevent the memory area of his/her own wireless communication apparatus (for example, a smart phone) from being used for the accompanying information of a large capacity despite his/her intention.

In addition, for example, it is not necessary to perform the deletion operation or the like in each case even when accompanying information is unnecessary for the user by making a setting indicating that only overwriting is performed on data to be written to the dedicated area for the accompanying information in the storage unit 460.

Also, for example, in the wireless communication apparatus in which the memory capacity of the dedicated area (the dedicated area for the accompanying information) for storing the accompanying information is set to be greater than or equal to a threshold value, information related to a service such as a discount ticket (for example, a discount ticket of associated goods) or a coupon may be additionally transmitted. Thereby, a service appropriate for this can be provided to each user who sets the memory capacity of the dedicated area (the dedicated area for the accompanying information) for storing the accompanying information to be greater than or equal to the threshold value. In addition, the user can appropriately receive a service greater than or equal to the normal service by setting the memory capacity of the dedicated area (the dedicated area for the accompanying information) for storing the accompanying information to be greater than or equal to the threshold value.

### 3. Third Embodiment

In the first and second embodiments of the present technology, an example in which the wireless communication apparatus downloading content related to a trial reading request and its trial reading key displays the content has been shown. However, when one person owns a plurality of wireless communication apparatuses, it is also assumed that content is displayed using any of the wireless communication apparatuses.

In the third embodiment of the present technology, an example in which content is shared by a plurality of wireless communication apparatuses is shown. Also, the configuration of the information processing system in the third embodiment of the present technology is approximately the same as that of the example illustrated in FIG. 1, 2, or the like. Thus, parts common with those of the first embodiment of the present technology are denoted by the same reference signs, and the description thereof is partially omitted.

[Example of Copy of Content]

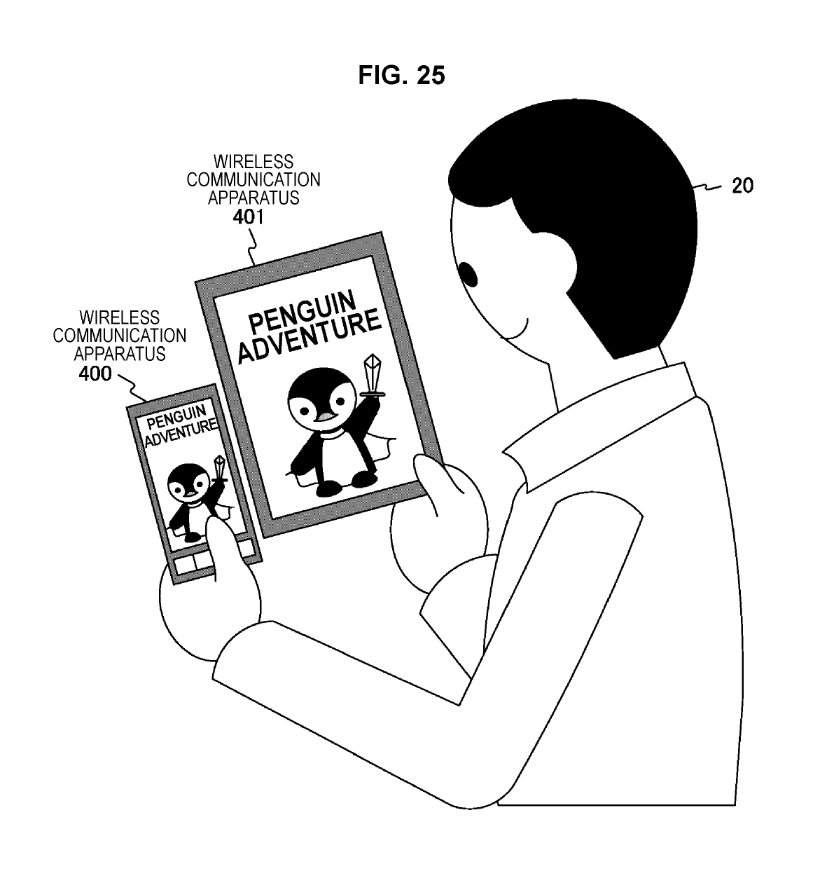

FIG. 25 is a simplified diagram when content and its license key are copied between the wireless communication apparatus 400 and the wireless communication apparatus 401 in the third embodiment of the present technology.

Here, the user 20 is assumed to own the wireless communication apparatus 400 and the wireless communication apparatus 401. In addition, through the above-described method, the user 20 is assumed to have downloaded desired content and its license key to the wireless communication apparatus 400.

Here, at present, there is a domain binding method in the DRM. This method enables one user to share one license key in a plurality of electronic devices. That is, for a domain (area) of one user, one license key can be shared. As described above, content (for example, an electronic publication) purchased by the user once can be freely used in a plurality of electronic devices within the domain.

For example, the user 20 owning the wireless communication apparatus 400 and the wireless communication apparatus 401 can directly copy content and its license key downloaded to the wireless communication apparatus 400 to the wireless communication apparatus 401. Thereby, the user 20 can use the content downloaded to the wireless communication apparatus 400 even in the wireless communication apparatus 401.

However, in order to set the wireless communication apparatus 401 as the electronic device within the domain of the user 20, it is necessary to receive authentication from the license server 300 in advance through some method. Hereinafter, the authentication method will be described.

[Example of Acquisition of Domain Key]

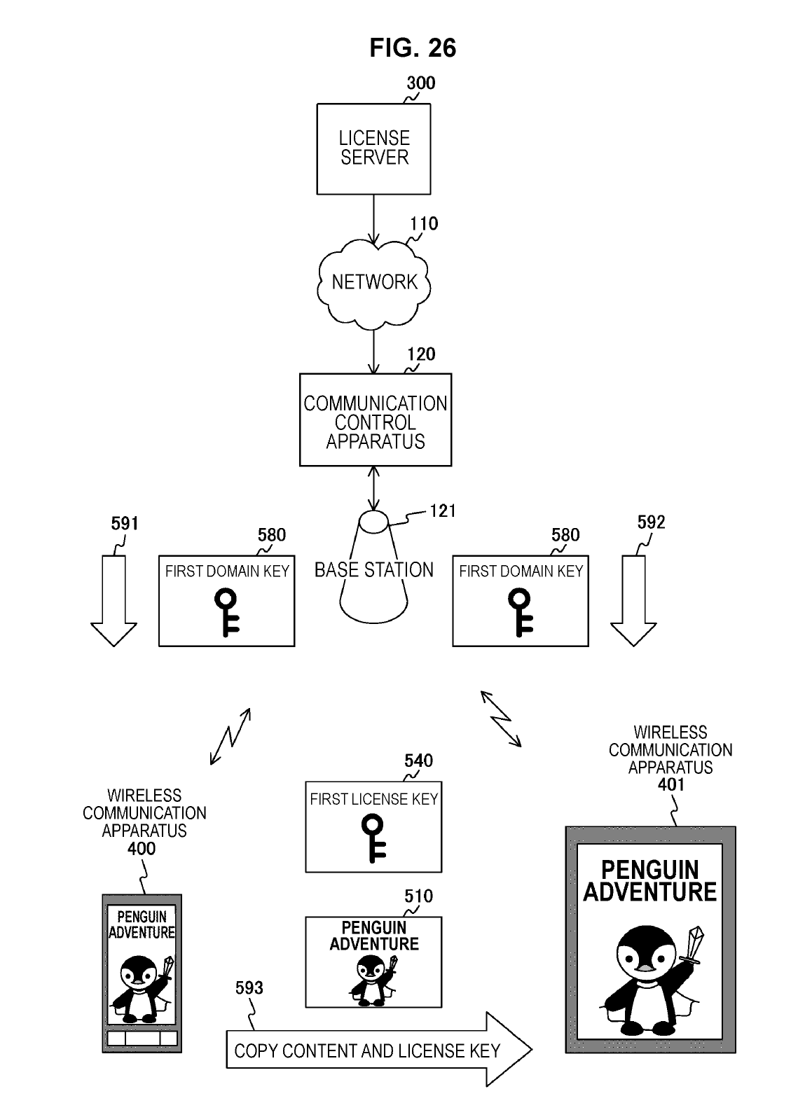

FIG. 26 is a simplified diagram illustrating a flow of data upon acquisition when a domain key is acquired using the wireless communication apparatus 401 in the third embodiment of the present technology.

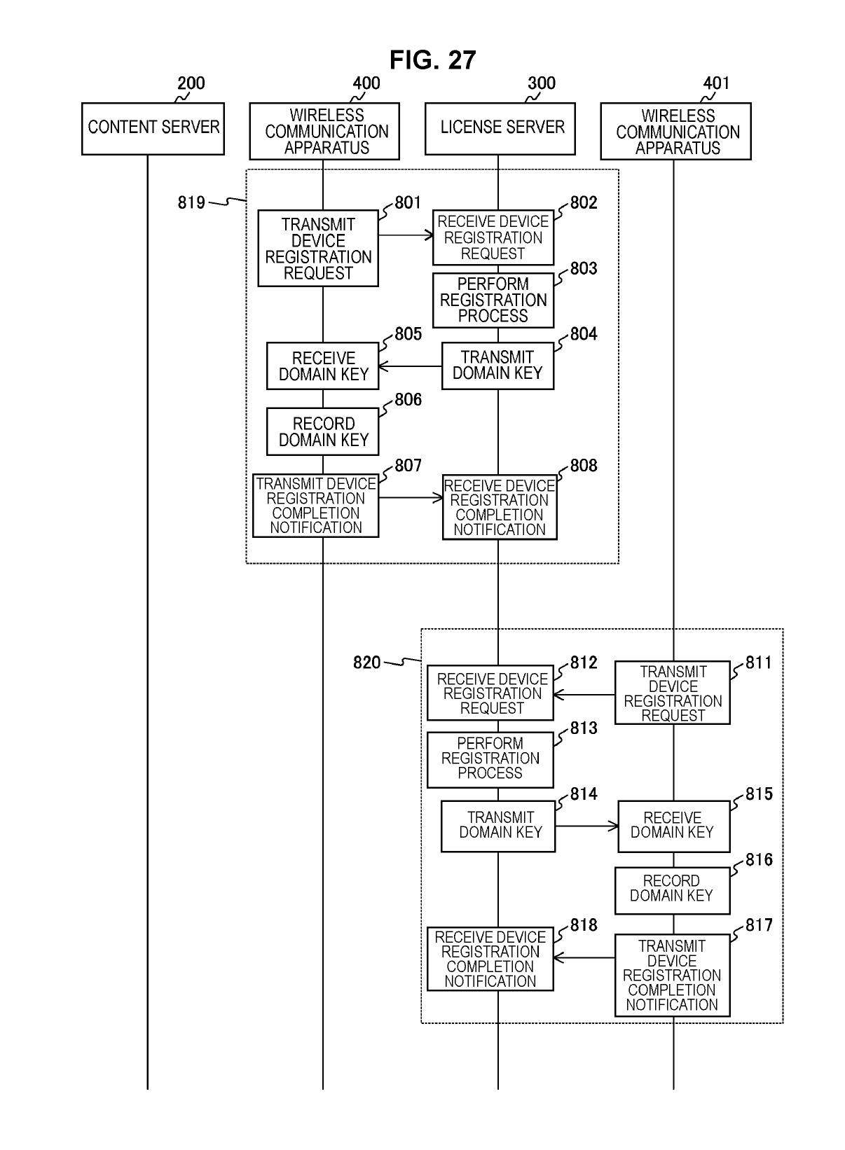

Here, registration for verifying that the wireless communication apparatus 401 is a related electronic device owned by the user 20 is necessary. This registration example will be described in detail with reference to FIG. 27.

For example, the user 20 acquires a domain key (first domain key 580) of the user 20 by accessing the license server 300 using the wireless communication apparatus 400 and performing a registration operation (591). Thereby, the wireless communication apparatus 400 is verified to be the related electronic device owned by the user 20.

Likewise, the user 20 acquires a domain key (first domain key 580) of the user 20 by accessing the license server 300 using the wireless communication apparatus 401 and performing a registration operation (592). Thereby, the wireless communication apparatus 401 is verified to be the related electronic device owned by the user 20.

As described above, the wireless communication apparatus 401 acquires the domain key (first domain key 580) of the user 20, and hence the content and its license key downloaded to the wireless communication apparatus 400 can be copied directly to the wireless communication apparatus 401 and used therein.

For example, the user 20 performs a copy operation for copying the content 510 and the first license key 540 downloaded to the wireless communication apparatus 400 directly to the wireless communication apparatus 401 using the wireless communication apparatus 400 and the wireless communication apparatus 401 (593). In this case, for example, the content 510 and the first license key 540 are transmitted from the wireless communication apparatus 400 to the wireless communication apparatus 401 using near-field wireless communication (for example, TransferJet).

Subsequently, the wireless communication apparatus 401 receiving the content 510 and the first license key 540 matches the first license key 540 against the first domain key 580 acquired in advance, and determines whether the content 510 is available. When the content 510 is determined not to be available as a result of the matching, nothing is performed, or the content 510 and the first license key 540 are deleted. On the other hand, when the content 510 is determined to be available, the user 20 can use the content 510 using the wireless communication apparatus 401.

[Example of Communication Upon Registration of Domain]

FIG. 27 is a sequence chart illustrating an example of a communication process between devices constituting the information processing system 100 in the third embodiment of the present technology. In FIG. 27, an example (819) in which the user acquires domain registration using the wireless communication apparatus 400 and an example (820) in which the user acquires domain registration using the wireless communication apparatus 401 are illustrated.

Here, the wireless communication apparatuses 400 and 401 and the license server 300 are assumed to be connected through wireless communication using the 3G network or wireless communication using a wireless LAN (for example, Wi-Fi). In addition, the wireless communication apparatuses 400 and 401 and the license server 300 may be connected using near-field wireless communication (for example, TransferJet).

Also, as described above, functional configurations of the wireless communication apparatus 400 and the wireless communication apparatus 401 are approximately the same. Thus, parts of the configuration of the wireless communication apparatus 401 corresponding to those of the wireless communication apparatus 400 denoted by the same reference signs as in the wireless communication apparatus 400 will be described below.

First, the example (819) in which the user acquires the domain registration using the wireless communication apparatus 400 will be described. In this example, initial domain registration is assumed to be performed using the wireless communication apparatus 400 by the user.

Initially, in order to perform the domain registration, the user performs an operation of transmitting a device registration request using the wireless communication apparatus 400. For example, the transmission operation is performed by inputting contents according to a rule of a provider that operates the license server 300.

As described above, when the transmission operation has been performed, the control unit 430 of the wireless communication apparatus 400 transmits the device registration request to the license server 300 (801 and 802). In the device registration request, terminal identification information or a terminal model (for example, information corresponding to the registered terminal information 334 illustrated in FIG. 6) of the wireless communication apparatus 400 is included along with information input according to the transmission operation.

When the device registration request has been received (802), the control unit 340 of the license server 300 performs a registration process based on the received device registration request (803). For example, the control unit 340 of the license server 300 records information included in the received device registration request in the registered terminal information 334 of the domain management DB 330. In addition, the control unit 340 of the license server 300 records information (domain information, a password, and a domain key) assigned to the wireless communication apparatus 400 transmitting the device registration request in the domain information 331, the password 332, and the domain key 333 illustrated in FIG. 6. Also, the user of the wireless communication apparatus 400 may set or correct the password or the like. In addition, the user of the wireless communication apparatus 400 is assumed to be notified of information (the domain information and the password) assigned to the wireless communication apparatus 400 through some method (for example, a mail or an electronic mail).

Subsequently, the control unit 340 of the license server 300 transmits the domain key (the domain key 333 illustrated in FIG. 6) to the wireless communication apparatus 400 performing the registration process (804 and 805).

When the domain key has been received (805), the control unit 430 of the wireless communication apparatus 400 causes the storage unit 460 to store the received domain key (806). Subsequently, the control unit 430 of the wireless communication apparatus 400 transmits a device registration completion notification for notifying that the device registration process has been completed to the license server 300 (807 and 808).

Next, the example (820) in which the user acquires the domain registration using the wireless communication apparatus 401 will be described. In this example, the domain registration using the wireless communication apparatus 400 is assumed to have already been performed.

Initially, in order to perform the domain registration, the user performs an operation of transmitting a device registration request using the wireless communication apparatus 401. For example, the transmission operation is performed by inputting contents according to a rule of a provider that operates the license server 300. For example, because the domain registration using the wireless communication apparatus 400 has already been performed, the domain information or password assigned during the domain registration is input.

When the transmission operation has been performed as described above, the control unit 430 of the wireless communication apparatus 401 transmits the device registration request to the license server 300 (811 and 812). In the device registration request, terminal identification information or a terminal model (for example, information corresponding to the registered terminal information 334 illustrated in FIG. 6) of the wireless communication apparatus 401 is included along with information (for example, the domain information or password) input according to the transmission operation.

When the device registration request has been received (812), the control unit 340 of the license server 300 performs a registration process based on the received device registration request (813). For example, the control unit 340 performs an authentication process by comparing information (for example, the domain information or password) included in the received device registration request to contents (for example, the domain information 331 and the password 332 illustrated in FIG. 6) of the domain management DB 330. Therefore, when each piece of the information serving as an object to be compared is identical, it is determined that a domain key can be transmitted. On the other hand, when at least one piece of the information serving as the object to be compared is not identical, it is determined to be difficult to transmit the domain key. As described above, when it is determined to be difficult to transmit the domain key, it is possible to prompt the wireless communication apparatus 401 to perform the transmission operation again by transmitting and displaying the fact that it is difficult to transmit the domain key to the wireless communication apparatus 401. Alternatively, an error notification may be transmitted and displayed to the wireless communication apparatus 401.

In addition, when it is determined that the domain key can be transmitted, the control unit 340 of the license server 300 records information included in the received device registration request in the registered terminal information 334 of the domain management DB 330.

Subsequently, the control unit 340 of the license server 300 transmits the domain key (the domain key 333 illustrated in FIG. 6) to the wireless communication apparatus 401 performing the registration process (814 and 815).

When the domain key has been received (815), the control unit 430 of the wireless communication apparatus 401 causes the storage unit 460 of the wireless communication apparatus 401 to record the received domain key (816). Subsequently, the control unit 430 of the wireless communication apparatus 401 transmits a device registration completion notification for notifying that the device registration process has been completed to the license server 300 (817 and 818).

[Example of Communication Upon Copy of Content]

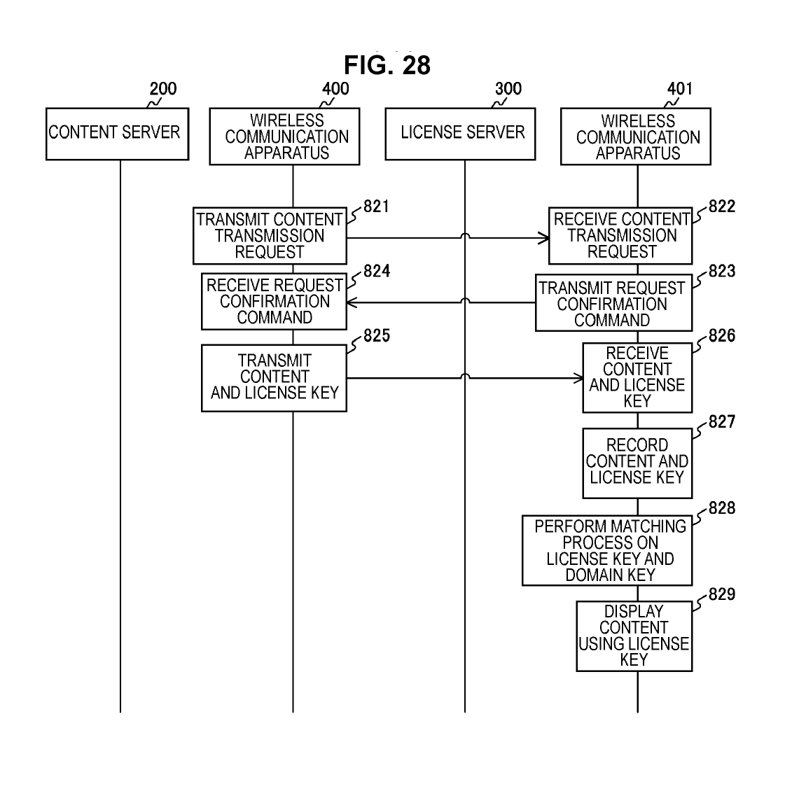

FIG. 28 is a sequence chart illustrating an example of a communication process between devices constituting the information processing system 100 in the third embodiment of the present technology. In FIG. 28, an example in which content and its license key are copied between the wireless communication apparatus 400 and the wireless communication apparatus 401 is illustrated.

Also, a connection between the wireless communication apparatus 400 and the wireless communication apparatus 401 is assumed to be established using near-field wireless communication (for example, TransferJet). In addition, the wireless communication apparatus 401 is assumed to acquire a domain key.

Initially, in order to perform the near-field wireless communication, the user causes the wireless communication apparatus 400 and the wireless communication apparatus 401 to be in contact with or in proximity to each other until a distance at which the near-field wireless communication is possible is reached as illustrated in FIG. 25. Therefore, the user performs an operation of transmitting a content transmission request in the wireless communication apparatus 400.

As described above, when the transmission operation has been performed, the control unit 430 of the wireless communication apparatus 400 transmits the content transmission request to the wireless communication apparatus 401 (821 and 822). When the content transmission request has been received (822), the control unit 430 of the wireless communication apparatus 401 transmits a request confirmation command corresponding to the content transmission request to the wireless communication apparatus 400 (823 and 824).

When the request confirmation command has been received (824), the control unit 430 of the wireless communication apparatus 400 transmits content and its license key corresponding to the operation of transmitting the content transmission request to the wireless communication apparatus 401 (825 and 826).

When the content and its license key have been received (826), the control unit 430 of the wireless communication apparatus 401 causes the storage unit 460 of the wireless communication apparatus 401 to record the received content and license key (827). Subsequently, the control unit 430 of the wireless communication apparatus 401 performs a process of matching the received license key against the domain key stored in the storage unit 460 (828). When the result of the matching process is that the received content is determined to be available (828), the control unit 430 of the wireless communication apparatus 401 causes the display unit 450 of the wireless communication apparatus 401 to display the content using the received license key (829). On the other hand, when the result of the matching process is that the received content is determined not to be available (828), the control unit 430 of the wireless communication apparatus 401 deletes the received content and its license key from the storage unit 460 of the wireless communication apparatus 401. In addition, the display unit 450 of the wireless communication apparatus 401 is caused to display the fact that it is difficult to display the received content.

Also, the case in which content and its license key are copied to another electronic device (for example, the wireless communication apparatus 402 illustrated in FIG. 1) can also be applied to the third embodiment of the present technology.

[Example of Operation of Wireless Communication Apparatus]

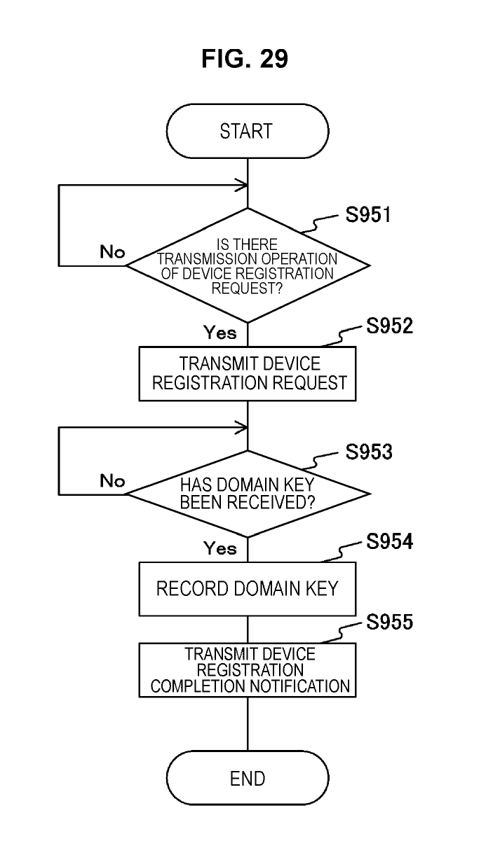

FIG. 29 is a flowchart illustrating an example of a processing procedure of a domain registration process by the wireless communication apparatus 400 in the third embodiment of the present technology.

Initially, the control unit 430 determines whether an operation of transmitting a device registration request has been performed (step S951), and continues monitoring when the operation of transmitting the device registration request has not been performed. On the other hand, when the operation of transmitting the device registration request has been performed (step S951), the control unit 430 transmits the device registration request to the license server 300 (step S952).

Subsequently, the control unit 430 determines whether a domain key has been received (step S953), and continues monitoring when no domain key has been received. On the other hand, when the domain key has been received (step S953), the control unit 430 causes the storage unit 460 to store the received domain key (step S954).

Subsequently, the control unit 430 transmits a device registration completion notification for notifying that the device registration process has been completed to the license server 300 (step S955).

[Example of Operation of Wireless Communication Apparatus]

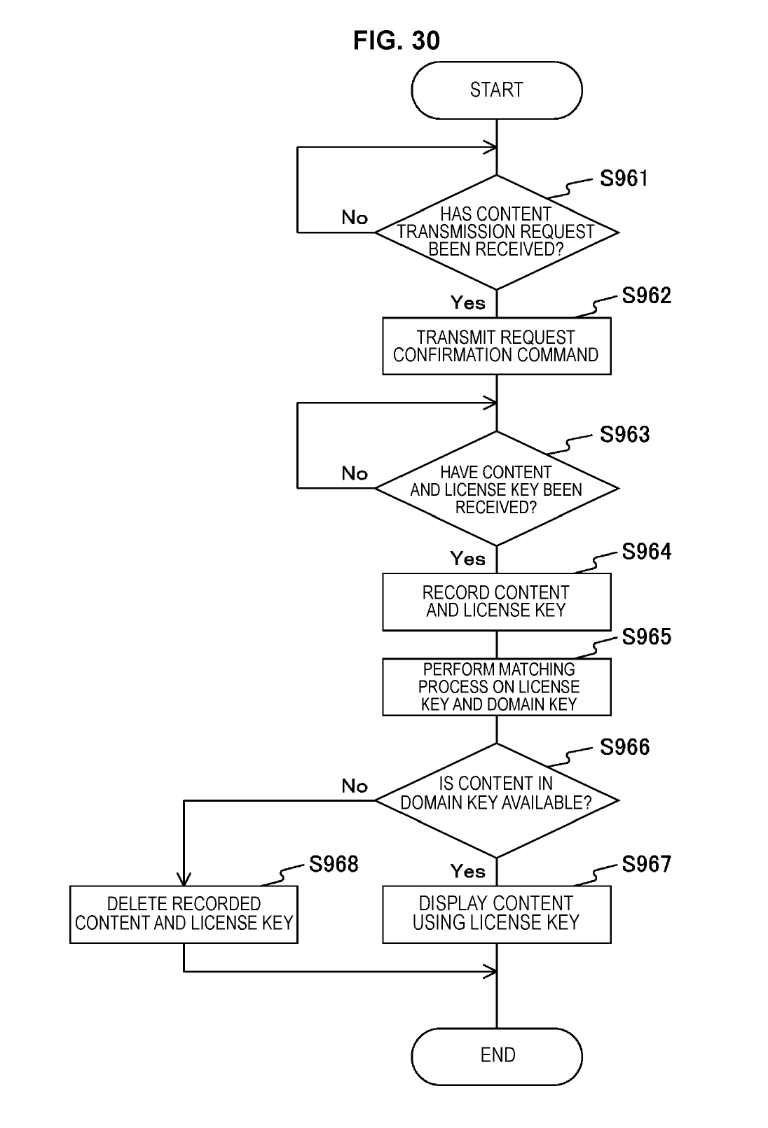

FIG. 30 is a flowchart illustrating an example of a processing procedure of a content copy process by the wireless communication apparatus 401 in the third embodiment of the present technology.

Initially, the control unit 430 of the wireless communication apparatus 401 determines whether a content transmission request has been received (step S961), and continues monitoring when no content transmission request has been received. On the other hand, when the content transmission request has been received (step S961), the control unit 430 of the wireless communication apparatus 401 transmits a request confirmation command to the wireless communication apparatus 400 (step S962).

Subsequently, the control unit 430 of the wireless communication apparatus 401 determines whether content and its license key have been received (step S963), and continues monitoring when content and its license key have not been received. On the other hand, when the content and its license key have been received (step S963), the control unit 430 of the wireless communication apparatus 401 causes the storage unit 460 of the wireless communication apparatus 401 to record the received content and license key (step S964).

Subsequently, the control unit 430 of the wireless communication apparatus 401 performs a process of matching the received license key against the domain key stored in the storage unit 460 (step S965). When the result of the matching process is that the received content is determined to be available (step S966), the control unit 430 of the wireless communication apparatus 401 causes the display unit 450 of the wireless communication apparatus 401 to display the content using the license key (step S967). On the other hand, when the received content is determined not to be available (step S966), the control unit 430 of the wireless communication apparatus 401 deletes the received content and its license key from the storage unit 460 of the wireless communication apparatus 401 (step S968). In addition, the display unit 450 of the wireless communication apparatus 401 is caused to display the fact that it is difficult to display the received content.

As described above, in the third embodiment of the present technology, content can be used in another wireless apparatus in addition to a wireless communication apparatus that has downloaded the content related to a trial reading request and its trial reading key. That is, content can be shared by a plurality of wireless communication apparatuses.

Also, although an example of an electronic publication distribution system for selling publications has been shown in the embodiment of the present technology, the embodiment of the present technology can also be applied to a distribution system for selling music or other content.

In addition, although an example in which TransferJet is used as near-field wireless communication has been shown in the embodiment of the present technology, other near-field wireless communication may be used. For example, wireless gigabit (WiGig) (a standard of high-speed wireless communication for which specs are being designed by the WiGig Alliance) may be used.

In addition, in the embodiment of the present technology, an example in which a license key for displaying all of the content is acquired after downloading content and a trial reading key in a bookstore and displaying part of content using the trial reading key has been shown. However, for example, trial reading content may be displayed by downloading the trial reading content (for example, data for displaying part of the content (for example, data obtained by partitioning the content)) in the bookstore. That is, only content for displaying part of the content may be initially downloaded as content whose use is restricted. In this case, after a display of the trial reading content, content for displaying the whole is set to be newly downloaded.

Note that the above described embodiments show examples of embodying the present disclosure, and there is a correspondence between the features in the embodiments and the respective features of the present disclosure. Similarly, there is a correspondence between the features of the present disclosure and the respective features in the embodiments of the present disclosure with the same reference numerals. However, the present disclosure is not limited to the embodiments, and can embody various modifications which do not deviate from the scope of the present disclosure.

Further, the procedures described in each of the aforementioned embodiments may be understood as a method including a series of these procedures, and may be understood as a program for causing a computer to execute the series of these procedures or a recording medium storing the program therein. As the recording medium, for example, a hard disk, a CD (a Compact Disc), an MD (a MiniDisc), a DVD (a Digital Versatile Disk), a memory card, or Blu-ray Disc (registered trademark) can be used.

Additionally, the present technology may also be configured as below.

(1) An information processing apparatus including:

a reception unit configured to receive an acquisition request for content that occurs according to near-field wireless communication to be performed by a wireless communication apparatus; and

a control unit configured to control transmission of content whose use is restricted among content related to the received acquisition request and accompanying information associated with the content to the wireless communication apparatus.

(2) The information processing apparatus according to (1),

wherein the reception unit is a near-field wireless communication unit that performs near-field wireless communication with the wireless communication apparatus, and

wherein the acquisition request is received according to a timing at which the near-field wireless communication with the wireless communication apparatus began.

(3) The information processing apparatus according to (1),

wherein the information processing apparatus is connected to a communication apparatus that performs the near-field wireless communication with the wireless communication apparatus, and

wherein the acquisition request is output from one of the wireless communication apparatus and the communication apparatus according to a timing at which the near-field wireless communication between the wireless communication apparatus and the communication apparatus began.

(4) The information processing apparatus according to any one of (1) to (3), wherein the control unit controls transmission to the wireless communication apparatus by imposing a use restriction on the accompanying information.
(5) The information processing apparatus according to (4), wherein the control unit controls transmission of content whose use is restricted among other content associated with content related to the received acquisition request as the accompanying information to the wireless communication apparatus.
(6) The information processing apparatus according to any one of (1) to (5), wherein the control unit controls transmission of key information for enabling part of the content to be available along with content related to the received acquisition request to the wireless communication apparatus.
(7) The information processing apparatus according to any one of (1) to (3) and (6), wherein the control unit controls transmission of service information for providing a user of the wireless communication apparatus with a predetermined service among information associated with content related to the received acquisition request as the accompanying information to the wireless communication apparatus.
(8) The information processing apparatus according to any one of (1) to (7), wherein the control unit controls a dedicated memory set in the wireless communication apparatus to store the accompanying information by transmitting the accompanying information to the wireless communication apparatus.
(9) The information processing apparatus according to (8), wherein the control unit controls transmission of only the accompanying information corresponding to an allowable amount of the dedicated memory to the wireless communication apparatus.
(10) The information processing apparatus according to any one of (1) to (9), wherein the control unit determines the accompanying information based on at least one of a place in which the near-field wireless communication is performed by the wireless communication apparatus, a user of the wireless communication apparatus, a date on which the near-field wireless communication is performed, and contents of content related to the received acquisition request.
(11) A wireless communication apparatus including:

a control unit configured to control acquisition of content whose use is restricted among content transmitted from an information processing apparatus according to an acquisition request for content that occurs according to near-field wireless communication and accompanying information whose use is restricted among information associated with the content from the information processing apparatus and control use of the acquired content and the acquired accompanying information in a use restriction range.

(12) An information processing system including:

a wireless communication apparatus including a control unit configured to control acquisition of content whose use is restricted among content transmitted from an information processing apparatus according to an acquisition request for content that occurs according to near-field wireless communication and accompanying information whose use is restricted among information associated with the content from the information processing apparatus and control use of the acquired content and the acquired accompanying information in a use restriction range; and

the information processing apparatus including a control unit configured to control transmission of content related to the acquisition request and the accompanying information to the wireless communication apparatus.

(13) An information processing method including:

receiving an acquisition request for content that occurs according to near-field wireless communication to be performed by a wireless communication apparatus; and

controlling transmission of content whose use is restricted among content related to the received acquisition request and accompanying information associated with the content to the wireless communication apparatus.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-121482 filed in the Japan Patent Office on May 29, 2012, the entire content of which is hereby incorporated by reference.

What is claimed is:

1. An information processing apparatus comprising:
a reception unit configured to receive an acquisition request for content that occurs according to near-field wireless communication to be performed by a wireless communication apparatus; and
a control unit configured to control transmission of content whose use is restricted among content related to the received acquisition request and accompanying information associated with the content to the wireless communication apparatus.

2. The information processing apparatus according to claim 1,
wherein the reception unit is a near-field wireless communication unit that performs near-field wireless communication with the wireless communication apparatus, and
wherein the acquisition request is received according to a timing at which the near-field wireless communication with the wireless communication apparatus began.

3. The information processing apparatus according to claim 1,
wherein the information processing apparatus is connected to a communication apparatus that performs the near-field wireless communication with the wireless communication apparatus, and
wherein the acquisition request is output from one of the wireless communication apparatus and the communication apparatus according to a timing at which the near-field wireless communication between the wireless communication apparatus and the communication apparatus began.

4. The information processing apparatus according to claim 1, wherein the control unit controls transmission to the wireless communication apparatus by imposing a use restriction on the accompanying information.

5. The information processing apparatus according to claim 4, wherein the control unit controls transmission of content whose use is restricted among other content associated with content related to the received acquisition request as the accompanying information to the wireless communication apparatus.

6. The information processing apparatus according to claim 1, wherein the control unit controls transmission of key information for enabling part of the content to be available along with content related to the received acquisition request to the wireless communication apparatus.

7. The information processing apparatus according to claim 1, wherein the control unit controls transmission of service information for providing a user of the wireless communication apparatus with a predetermined service among information associated with content related to the received acquisition request as the accompanying information to the wireless communication apparatus.

8. The information processing apparatus according to claim 1, wherein the control unit controls a dedicated memory set in the wireless communication apparatus to store the accompanying information by transmitting the accompanying information to the wireless communication apparatus.

9. The information processing apparatus according to claim 8, wherein the control unit controls transmission of only the accompanying information corresponding to an allowable amount of the dedicated memory to the wireless communication apparatus.

10. The information processing apparatus according to claim 1, wherein the control unit determines the accompanying information based on at least one of a place in which the near-field wireless communication is performed by the wireless communication apparatus, a user of the wireless communication apparatus, a date on which the near-field wireless communication is performed, and contents of content related to the received acquisition request.

11. A wireless communication apparatus comprising:
a control unit configured to control acquisition of content whose use is restricted among content transmitted from an information processing apparatus according to an acquisition request for content that occurs according to near-field wireless communication and accompanying information whose use is restricted among information associated with the content from the information processing apparatus and control use of the acquired content and the acquired accompanying information in a use restriction range.

12. An information processing system comprising:
a wireless communication apparatus including a control unit configured to control acquisition of content whose use is restricted among content transmitted from an information processing apparatus according to an acquisition request for content that occurs according to near-field wireless communication and accompanying information whose use is restricted among information associated with the content from the information processing apparatus and control use of the acquired content and the acquired accompanying information in a use restriction range; and
the information processing apparatus including a control unit configured to control transmission of content related to the acquisition request and the accompanying information to the wireless communication apparatus.

13. An information processing method comprising:
receiving an acquisition request for content that occurs according to near-field wireless communication to be performed by a wireless communication apparatus; and
controlling transmission of content whose use is restricted among content related to the received acquisition request and accompanying information associated with the content to the wireless communication apparatus.
